(19) United States
(12) Patent Application Publication
(10) Pub. No.: US 2024/0364257 A1
(43) Pub. Date: Oct. 31, 2024

(54) PHOTOVOLTAIC WINDOW BLIND SYSTEM

(71) Applicant: Alfonso DE LA FUENTE SANCHEZ, Saanich (CA)

(72) Inventor: Alfonso DE LA FUENTE SANCHEZ, Saanich (CA)

(21) Appl. No.: 18/577,646

(22) PCT Filed: Jul. 19, 2022
(86) PCT No.: PCT/CA2022/051119

§ 371 Date: Jan. 8, 2024

Related U.S. Application Data
(60) Provisional application No. 63/223,344, filed on Jul. 19, 2021.

(51) Int. Cl. H02S 30/20; E06B 9/24; E06B 9/32; E06B 9/42; H02S 20/26

(52) U.S. Cl. CPC H02S 30/20; E06B 9/32; E06B 9/42; H02S 20/26; E06B 2009/2476

(57) ABSTRACT

A window blind system that has multiple stacks of materials that capture solar radiation, transforming it into energy. A supplemental flexible solar panel is provided that can be deployed in a vertical way via a window. A photovoltaic blind controller uses input from sensors to control the blinds. Each blind adheres to a window's surface when deployed. Window covering strips, which capture sun ray's and convert them to usable energy, cover an area on a window which is not covered by the blind. All components of the system share energy storage space and are connected to the same grid.

### FIELD

There is described a window blind system that is capable of solar power generation.

### BACKGROUND

A solar cell, or photovoltaic cell converts the energy of light directly into electricity by the photovoltaic effect, which is a physical and chemical phenomenon. It is a type of photoelectric cell and can be defined as a device whose electrical characteristics, such as current, voltage, or resistance, vary when exposed to light. Individual solar cell devices can be combined to form modules, otherwise known as solar panels. Solar cells are described as being photovoltaic, irrespective of whether the source is sunlight or an artificial light.

The operation of a photovoltaic (PV) cell requires three basic attributes. The first attribute is the absorption of light, generating electron-hole pairs or excitons. Second, the separation of charge carriers of opposite types. Lastly, it requires the separate extraction of those carriers to an external circuit. In contrast, a solar thermal collector supplies heat by absorbing sunlight, for the purpose of either direct heating or indirect electrical power generation from heat. A “photo electrolytic cell” (photoelectrochemical cell), on the other hand, refers either to a type of photovoltaic cell (like that developed by Edmond Becquerel and modern dye-sensitized solar cells), or to a device that splits water directly into hydrogen and oxygen using only solar illumination.

One familiar with the art will appreciate that the energy capturing layer is at least 75% perovskite, wherein a perovskite solar cell (PSC) is a type of solar cell which includes a perovskite-structured compound, most commonly a hybrid organic-inorganic lead or tin halide-based material, as the light-harvesting active layer. Perovskite materials, such as methylammonium lead halides and all-inorganic cesium lead halide, are cheap to produce and simple to manufacture.

There have been previously proposed window blind systems that are capable of generating power from solar energy. Examples includes U.S. Patent Publication No. 20191155779 titled “Tracking type window blind apparatus using solar modules” and U.S. Patent Publication No. 20200080369 titled “Dual purpose foldable solar electricity supply apparatus for outdoor and window blind”.

### SUMMARY

In one embodiment an indoor photovoltaic blind is provided comprising: in order, a substrate stack which includes a upper end and a lower end, the substrate stack comprising a first outer layer translucent electrode, a first hole transport layer, a first energy capturing layer, a first electron transport layer, an inner layer transparent electrode and a plain transparent film; and a headrail, wherein the upper end of the substrate stack is connected to the headrail.

In the indoor photovoltaic blind, the substrate stack may further comprise a second outer layer translucent electrode, a second hole transport layer, a second energy capturing layer, a second electron transport layer, and an electrochromic layer, which includes an inner side and an outer layer.

In the indoor photovoltaic blind, the first energy capturing layer may be at least 75% perovskite.

In the indoor photovoltaic blind, the substrate stack may be flexible.

The indoor photovoltaic may further comprise an energy management system which is attached to the headrail and is in electrical communication with the outer layer translucent electrode and the inner layer transparent electrode.

The indoor photovoltaic blind may further comprise a single sided reflective layer and a double-sided reflective layer.

In the indoor photovoltaic blind, the headrail may retain one or more of a battery, a connector, a plug, a light, a charger, a motor, a light projector and a video projector.

In the indoor photovoltaic blind, the light projector may be positioned to projects light towards the outer side of the.

In another embodiment, a flexible solar panel is provided for use with a window, the flexible solar panel comprising: a support fixture; a flexible panel which is attached to the support fixture and includes a lower end; at least one solar cell that is retained on the flexible panel; a power hub which is in electrical communication with the solar cell; and a flat cable in electrical communication with the power hub.

The flexible solar panel may further comprise a controller which includes: a power management system for use with one or more of a battery and an inverter; a processor; a memory; a network connection and a solar cell position controller.

In the flexible solar panel, the support fixture may comprise one or more of an adherent gel, a hook, a loop-and-hook mechanism and an adhesive.

The flexible solar panel may further comprise a tilt adjustment mechanism which retains the solar cell on the flexible panel.

In the flexible solar panel, the tilt adjustment mechanism may comprise a servo motor under control of the controller.

In the flexible solar panel, the tilt adjustment mechanism may comprise a hand operated lever system.

In the flexible solar panel, the tilt adjustment mechanism may comprise an inflatable system.

In the flexible solar panel, the inflatable system may include an inflatable slat and a manually inflatable valve or a pneumatic motor.

The flexible solar panel may further comprise a counterweight attached to the lower edge or attached proximate to the lower edge of the solar panel sheet.

In another embodiment, a smart photovoltaic blind is provided, the smart photovoltaic blind comprising: a blind which includes a multiplicity of vertical or horizontal slats and at least one solar cell on the slats; a controller including a processor, a memory, a communication module, a power supply and a receiver transmitter module; a temperature sensor; at least one sensor selected from the group consisting of a photo sensor, a humidity sensor and a presence sensor; and a servo motor in electronic communication with the processor and in mechanical communication with the slats of the blind; wherein the memory is configured to instruct the processor upon receipt of a temperature reading to send instructions to the servo motor to adjust the slats to a desired angle.

In yet another embodiment, a retractable, adherent photovoltaic blind is provided for covering a window, the retractable, adherent photovoltaic blind comprising: a blind which has an inside and an outside; at least one opaque, translucent or transparent solar cell which is mounted to the outside of the blind; and a ballast, which rotatably and releasably retains the blind, wherein the blind is configured to releasably adhere to the window.

In the retractable, adherent photovoltaic blind, the outside of the blind may include an outer coating of one or more of a film, a foam, a cloth, and a rubber and a pressure-sensitive coating which coats the outer coating, and is one or more of acrylic, a rubber-based coating, or a silicone-based adhesive, and wherein the inside of the blind includes an inner coating of one or more of a film, a foam, a foil, a cloth, and a rubber, and a repellent coating which coats the inner coating to reduce adhesion of the inside and the outside of the blind when retracted.

The retractable, adherent photovoltaic blind may further comprise a static inducer which is retained in the ballast, wherein the outside of the blind includes: an outer coating of one or more of a film, a foam, a cloth and a rubber; and a static induced material on the outer coating; and further comprising: the outside surface coat of the photovoltaic blind shade comprising one or more from the group of films, foams, foils, cloths, rubbers, wherein the outside surface coat comprises a material that can be induced with static and is in electrical communication with the static inducer.

In the retractable, adherent photovoltaic blind, the static inducer may comprise one or more of a contact-induced static inducer, a pressure-inducible static inducer, a heat-inducible static inducer, and a charge-inducible static inducer.

In another embodiment, a photovoltaic window covering strip is provided, the photovoltaic window covering strip comprising: a strip which includes an inner surface and an outer surface; at least one solar cell mounted on the outer surface; and an adherent on the outer surface.

The photovoltaic window covering strip may comprise a multiplicity of sections that are spliced together.

The photovoltaic window covering strip may further comprise a battery in electrical communication with the solar cell.

In another embodiment, an energy storage and distribution system is provided, the energy storage and distribution system comprising: a first photovoltaic device including a first photovoltaic energy harvesting module, a first energy storage module, a first controller comprising a processor, a memory and a wireless radio, and one or more first sensors selected from the group consisting of light, weather, temperature, energy use and energy storage sensors; a second photovoltaic device including a second photovoltaic energy harvesting module, a second energy storage module, a second controller comprising a processor, a memory and a wireless radio, and one or more second sensors selected from the group consisting of light, weather, temperature, energy use and energy storage sensors; a grid which is in electrical communication with the first photovoltaic device and the second photovoltaic device; and a server, which is in wireless communication with the first photovoltaic device and the second photovoltaic device, wherein the server is configured to receive a storage capacity dataset from each of the first photovoltaic device and the second photovoltaic device, determine whether an energy transfer between the first and second photovoltaic devices is required and instruct one photovoltaic device to transfer energy via the grid to the other photovoltaic device, as needed.

According to a first aspect there is provided a photovoltaic blind apparatus comprising multiple stacks of materials that captures solar radiation, transforming it into electrical energy, while reducing the level of sunlight and solar heating that comes through the window.

According to a second aspect there is provided a flexible solar panel that can be deployed, temporarily or permanently, in a vertical way via a window.

According to a third aspect there is provided a photovoltaic blind controller including sensors that detect the presence of people in the room, the location of the sun, as well as the temperature in the room, and correlates the data with a database that comprises the desired temperature inside the room. The controller sends commands to a blind to deploy and tilt or to third party peripherals like the room smart thermostat to control the temperature in combination with the deployment of the blind.

According to a fourth aspect there is provided a retractable photovoltaic blind shade that adheres to a window's surface while the photovoltaic blind shade is deployed and detaches from the window's surface when it is retracted. In a first embodiment of the technology, the retractable photovoltaic blind is coated with a removable and/or reusable pressure-sensitive adhesive. In a second embodiment of the technology the retractable photovoltaic blind uses electrostatic force to adhere to the window's surface.

According to a fifth aspect there is provided a photovoltaic window covering strip that covers an area on a window which is not covered by a photovoltaic blind, usually between the photovoltaic blind and a window frame. The photovoltaic window covering strip captures sun rays and converts it to usable energy.

According to a sixth aspect there is provided a photovoltaic device that has energy storage capability that shares its space with other photovoltaic devices connected to the same grid that communicate between the devices using a common network.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1A shows an example of three configurations of photovoltaic blinds.

FIG. 1B shows a photovoltaic blind apparatus in the form of either a roller, retractable blind or shade.

FIG. 2A shows a photovoltaic blind apparatus in the form of either a roller, retractable blind or shade.

FIG. 2B shows the flexible substrate stack from FIG. 1A, along with its various components.

FIG. 2C shows the outer and inner layers of the translucent electrode.

FIG. 3A shows a second embodiment of the technology in the form of a venetian blind or horizontal blind.

FIG. 3B shows a third embodiment of the technology in the form of a Persian or slat blind.

FIG. 3C shows a fourth embodiment of the technology in the form of a vertical blind.

FIG. 4 shows the headrail with a projected light beam or a video projector.

FIG. 5A shows a diagram of a flexible solar panel apparatus, along with its components.

FIG. 5B shows a diagram of a flexible solar panel apparatus, in another embodiment of the technology than in FIG. 5A.

FIG. 6A shows a front view of the flexible solar panel apparatus, when installed outside of a window.

FIG. 6B shows a front view of a different application of the technology where the apparatus hangs from a window aperture but rests on the window itself, rather than off a wall.

FIG. 7A shows a side view of the technology, where the flexible solar apparatus is hanging against the exterior of a building from a window opening.

FIG. 7B shows the same photovoltaic blind as FIG. 7A, with the slats with solar cells tilted facing the sun.

FIG. 7C shows a side view of a building with another embodiment of the technology of the flexible solar apparatus.

FIG. 7D shows a closer look at the same embodiment of the technology of FIG. 7C.

FIG. 8 shows a side view of another embodiment of the technology, where the tilt adjustment mechanism comprises a lever system operated by a knob.

FIG. 9A shows a side view of another embodiment of the technology, where the flexible solar apparatus mechanism comprises an inflatable system.

FIG. 9B shows the same embodiment of the technology from FIG. 9A with the inflatable slats in the inflated position.

FIG. 10A shows the deflated inflatable units that tilt the solar cells.

FIG. 10B shows the inflated inflatable unit that tilt the solar cells.

FIG. 11 shows a diagram of the smart photovoltaic blind controller.

FIG. 12 is a diagram of how the smart automated blind system connects to other devices.

FIG. 13 is a flow chart showing the functioning of the smart automated blind system.

FIG. 14 is a flowchart describing a secondary embodiment of the technology.

FIG. 15 shows a diagram of a retractable photovoltaic blind apparatus.

FIGS. 16A, 16B, 16C, 16D show a side perspective view of the retractable photovoltaic blind.

FIGS. 17A and 17B show a side close up view of the photovoltaic blind shade.

FIG. 18 shows a side close up view of a second embodiment of the technology.

FIGS. 19A, 19B, 20A, 20B, 21A, 21B are flowcharts describing the method for the operation of the retractable photovoltaic blind apparatus.

FIG. 22A shows a diagram of the components in a photovoltaic window covering strip apparatus.

FIG. 22B shows a diagram of components in another embodiment of the technology.

FIG. 23 shows a front view of a photovoltaic blind installed in a window, showing the width area to cover the space between the photovoltaic blind and the frame of the window might have a gap.

FIG. 24A is a front view of the photovoltaic window covering strip apparatus.

FIG. 24B is a back view of the photovoltaic window covering strip apparatus.

FIG. 24C is a front view of the photovoltaic window covering strip apparatus installed in a window.

FIG. 24D is a front view of the photovoltaic window covering strip installed in a window.

FIG. 24E is a front view of a side-by-side installation of a couple of photovoltaic window covering strip installed in a window.

FIG. 25 shows a front view of another embodiment of the technology.

FIG. 26 displays a block diagram of a photovoltaic device.

FIG. 27A is a diagram of multiple photovoltaic devices connected to the same grid.

FIG. 27B shows another embodiment of the technology where the server further comprises communication with a smart device.

FIG. 28 is a flowchart explaining the step-by-step process the server follows.

### DETAILED DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

The various aspects of the photovoltaic blind system will now be described.

### Electrochromic Photovoltaic Blinds

This is a photovoltaic blind comprising multiple stacks of materials that captures solar radiation, transforming it into energy, while reducing the level of sunlight and solar heating that comes through the window.

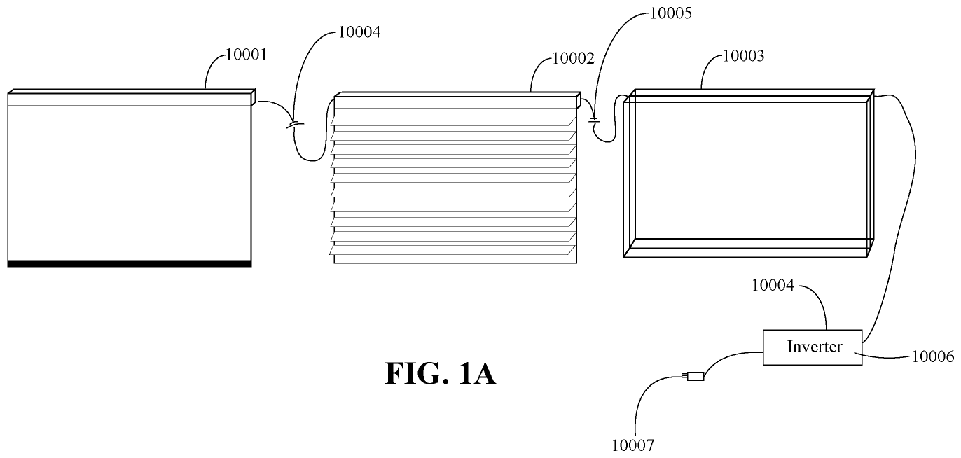

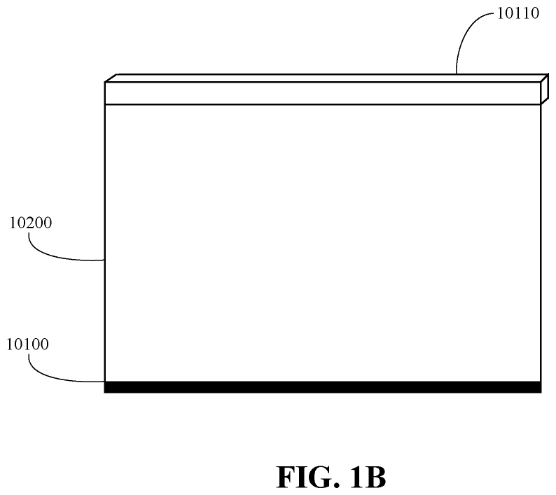

FIG. 1A shows an example of three configurations of photovoltaic blinds. The three types of blinds shown are a roll-down blind (10001), a horizontal blind (10002), and a storm panel (10003). Additionally, a cell blind or honeycomb blind may be used. The exact type of perovskite blind can change, but the system is established as a daisy chained system that feeds into a centralized inverter, which can feed into the home power grid. The energy gathered from sunlight that is passing through the windows is captured in the blind and converted to usable electricity. In one embodiment of the technology the blinds are daisy chained (10004, 10005) towards a central inverter (10006) to where the direct current power is converted to alternating current power. The 3-prong alternating current plug (10007) is optional, and out-going power may be wired directly into the housing wiring system if the amperage exceeds the rated plug limit.

FIG. 1B shows a photovoltaic blind in the form of either a roller shade also known as retractable blind or shade. The photovoltaic blind (10200) is a flexible substrate stack (10100) that is mechanically connected to a headrail (10110) which supports the blind (10200).

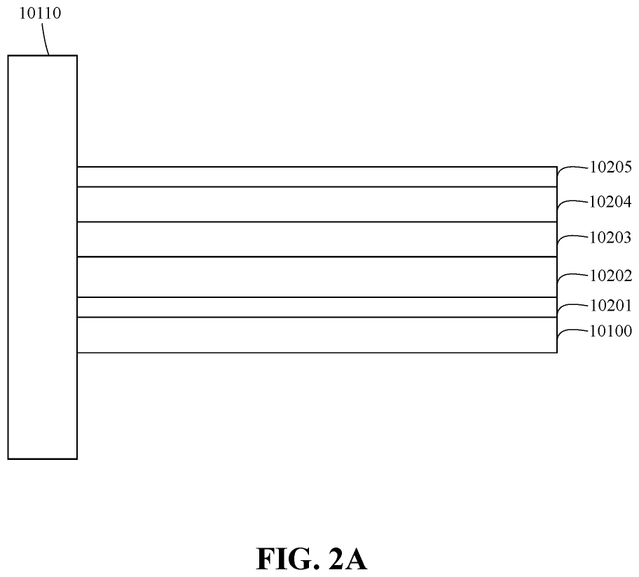

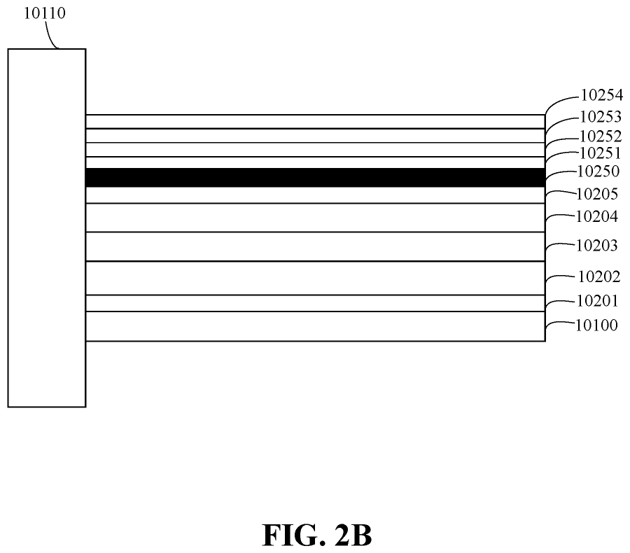

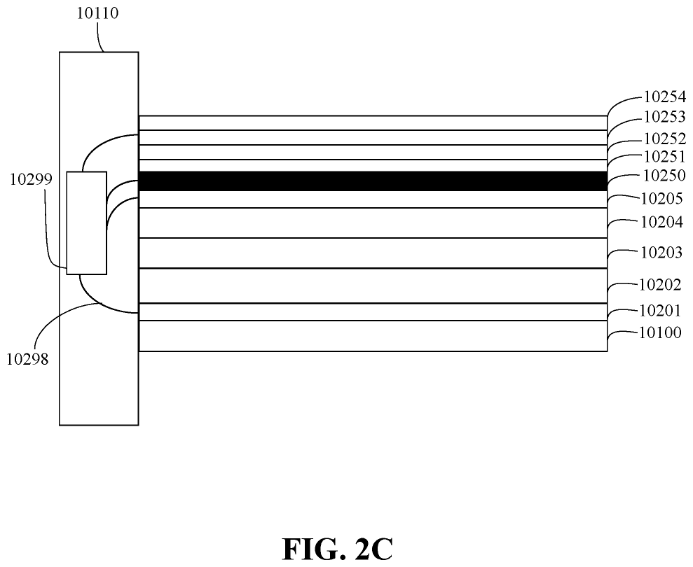

FIG. 2A shows the composition of the flexible substrate stack (10100) from FIG. 1B. The stack comprises a translucent electrode (10201), a translucent electron transport layer (10202), a first energy capturing layer made of translucent perovskite (10203), a translucent hole transport layer (10204) and a translucent top electrode all on a transparent film (10205). Wherein the electrochromic photovoltaic blind (10200) is mechanically connected to the headrail (10110).

FIG. 2B shows another embodiment of the technology wherein the substrate stack shown in FIG. 2A further comprises a second outer layer translucent electrode (10250), a second hole transport layer (10251), a second energy capturing layer (10252), a second electron transport layer (10253), a backing layer (10254) consisting of an electrochromic layer that changes from translucent to opaque based on the amount of light it perceives.

In another embodiment of the technology the apparatus comprises a single sided reflective layer, and a double-sided reflective layer.

By adding a second layer of photovoltaic material, two non-overlapping band gaps can be selected to allow light of a wider frequency range to be used, allowing for the Shockley-Queisser limit to be passed. This can increase the amount of solar energy collected and increase efficiency. In another embodiment of the technology the energy capturing layers include a hole transport layer and an electron transport layer, wherein the electron and hole transport layers are transparent electrodes made of specific materials that allow the flow of electrons within the perovskite solar cells.

One familiar with the art will appreciate that electrochromism is the phenomenon where the color or opacity of a material changes when a voltage is applied. By doing so, an electrochromic layer can block different light spectrums or band gaps instantaneously and on demand. The ability to control transmittance of near infrared light can increase the energy efficiency of a building, reducing the amount of energy needed to cool during summer and heat during winter.

As the color change is persistent and energy need only be applied to effect a change, electrochromic materials are used to control the amount of light and heat allowed to pass through a surface, most commonly smart windows. One popular application is in the automobile industry where it is used to automatically tint rear-view mirrors in various lighting conditions.

The phenomenon of electrochromism occurs in some transition metal oxides which conduct both electricity and ions, such as tungsten trioxide (WO₃). These oxides have octahedral structures of oxygen which surround a central metal atom and are joined together at the corners. This arrangement results in a three-dimensional nanoporous structure with “tunnels” between individual octahedral segments. These tunnels allow dissociated ions to pass through the substance when they are motivated by an electric field. Common ions used for this purpose are H+ and Li+. The electric field is typically induced by two flat, transparent electrodes which sandwich the ion-containing layers. As a voltage is applied across these electrodes, the difference in charge between the two sides causes the ions to penetrate the oxide as the charge-balancing electrons flow between the electrodes. These electrons change the valency of the metal atoms in the oxide, reducing their charge, as in the following example of tungsten trioxide:

WO3+n(H++e−)→HnWO3

This is a redox reaction, since the electroactive metal is accepting electrons from the electrodes, forming a half-cell. Strictly speaking the electrode as a chemical unit comprises the flat plate as well as the semiconducting substance in contact with it. However, the term electrode often refers to only the flat plate(s), more specifically called the electrode substrate.

Photons which reach the oxide layer can cause an electron to move between two nearby metal ions. The energy provided by the photon causes movement of an electron which in turn causes optical absorption of the photon. For example, the following process occurs in tungsten oxide for two tungsten ions a and b:

W5+a+W6+b+photon→W6+a+W5+b

Electrochromic materials, also known as chromophores, affect the optical color or opacity of a surface when a voltage is applied. Among the metal oxides, tungsten oxide (WO3) is the most extensively studied and well-known electrochromic material. Others include molybdenum, titanium and niobium oxides, although these are less effective optically.

For organic materials, viologens have been commercialized on small scale. A variety of conducting polymers are also of interest, including polypyrrole, poly (2,3-dihydrothieno[3,4-b][1,4]dioxane-5,7-diyl)), and polyaniline. Viologen is used in conjunction with titanium dioxide (TiO2, also known as titania) in the creation of small digital displays. It is hoped that these displays will replace liquid crystal displays as the viologen, which is typically dark blue, provides a higher contrast than the bright white of titanium dioxide, thereby increasing the visibility of a display.

The backing layer (10254) can be made of multiple layers where the first and last layers are transparent substrates made of silica (SiO₂) or other materials and two electrodes are needed to apply the voltage, which in turn will push (or pull) Li+ ions from the ion storage layer, through the electrolyte into the electrochromic material (or vice versa). Applying a high voltage pushes lithium-ions into the electrochromic layer, deactivating the electrochromic material. Making the layer transparent. By applying a lower voltage the concentration of Li-ions in the electrochromic layer decreases, thus activating near infrared-active tungsten oxide or other material used. Depending on the electrochromic material used, different parts of the spectrum can be blocked, this way ultraviolet, visible and infrared light can be independently reflected at the will of a user.

FIG. 2C shows how the outer layer translucent electrode (10201) and the inner layer transparent electrodes (10253, 10250, 10205, 102010 are connected by an electrical connection (10298) to an energy management system (10299) located at the headrail (10110). One familiar with the art will appreciate that the energy management system can be connected to a battery, a connector, a plug, a light emitter, a charger, a motor, which are retained by the headrail (10301).

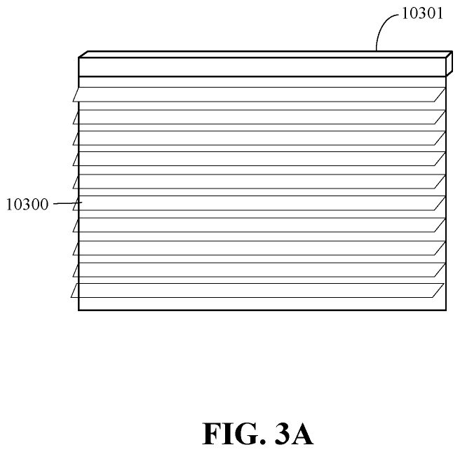

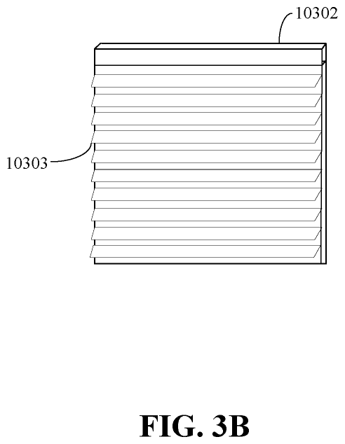

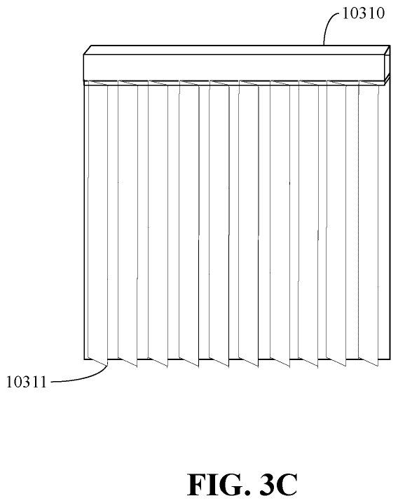

FIG. 3A shows a third embodiment of the technology in the form of a venetian blind or horizontal blind. In this embodiment, the substrate stack is rigid or flexible depending on the blind type (10300) and connected to a headrail (10301).

A venetian blind has horizontal slats that are placed about one another. They are basic slatted blinds made of metal or plastic; wooden slats are sometimes used but in the U.S. these are now usually referred to as wood blinds or bamboo blinds. They are suspended by strips of cloth called tapes, or by cords, by which all slats in unison can be rotated through nearly 180 degrees. The slats can be rotated such that they overlap with one side facing inward and then in the opposite direction such that they overlap with the other side facing inward. Between those extremes, various degrees of separation may be affected between the slats by varying the rotation. There are also lift cords passing through slots in each slat. When these cords are pulled, the bottom of the blind moves upward, causing the lowest slats to press the underside of the next highest slat as the blind is raised. A modern variation of the lift cords combines them with the rotational cords in slots on the two edges of each slat. This avoids the slots otherwise required to allow a slat to rotate despite a lift cord passing through it, thus decreasing the amount of light passing through a closed blind. Slat width can be between 16 and 120 mm, with 25 mm being a common width.

FIG. 3B shows a fourth embodiment of the technology in the form of a Persian or slat blind (10302), wherein the substrate stack is rigid or flexible depending on the blind type and use.

The most common window blinds are Persian blinds, which consist of many horizontal slats (10303), usually of metal or vinyl, connected with string such that they can be rotated to allow light to pass between the slats, rotated up to about 170 degrees to hide the light, or pulled up so that the entire window is clear. Vertical blinds consist of slats of stiffened fabric, plastic, or metal hanging by one end from a track; like the horizontal versions, the slats can be rotated 90 degrees to allow light to pass through or to fold up on one side of a door or window. Vertical blinds are very good at controlling how much natural or exterior light comes into a room, due to the ability of the slats to close tightly.

FIG. 3C shows a fifth embodiment of the technology in the form of a vertical blind (10310), wherein the substrate stack is rigid or flexible depending on the blind type and use. Unlike horizontal blinds, vertical blinds are less likely to collect dust because they stand vertically (10311). Since they draw to the side rather than lifting and lowering, they are easier and faster to operate. They operate better on doors and windows that also slide from side to side. In the 1970s there were few choices of fabric-usually beige or white, which had to have stiffener embedded to prevent fraying, rather like on roller blinds fabric but using a thicker textile.

Vertical blinds became available in flat plastic (PVC), fabric, embossed PVC, faux wood materials, metal, wood and also S-curved slats. A more modern modification is to offer them with wood trim at top and bottom-sometimes midway as well-and these are usually described as ‘Japanese Vertical blinds’ because they are often co-ordinated with Japanese style Shoji blinds using the same timber. Vertical blinds were most popular in the United Kingdom during the 1990s, since when sales have slowed as they lost popularity with a younger generation.

Stationary vertical blinds are hung in the doorways of some homes and businesses which generally leave the door open. Movement of the blind may signal a change in air flow, or someone entering the doorway. More commonly however, these vertical blinds are made of thick plastic. In the cold rooms of food businesses, this slows the heat leakage into the cold room. In warmer climates, vertical blinds discourage flies and some other insects from entering the building. In certain areas of the United Kingdom window blinds are used to disguise the fact that offices have computers in them and are used as a burglary deterrent.

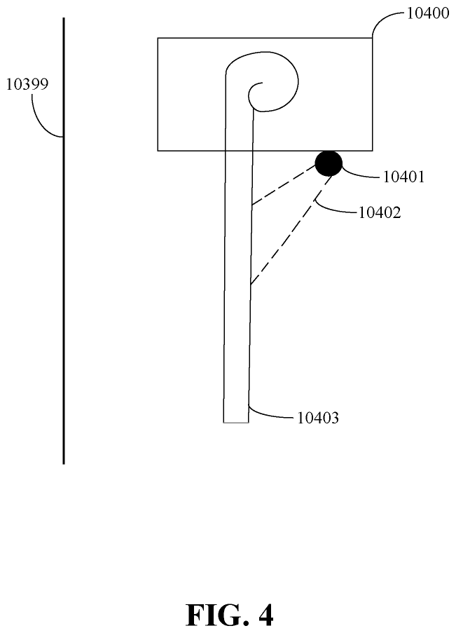

FIG. 4 shows a side view of the blind (10403) against a window (10399), where the headrail (10400) comprises a video projector (10401), which projects a light beam (10402) towards the outer side of the backing layer (10254) of the roller blind (10403). In another embodiment of the technology, the projected light beam comes from a video projector, a light transparency projector, and a laser projector.

### Flexible Solar Panel that Rolls Down a Building Facade

This is a flexible solar panel that can be deployed, temporary or permanent, in a vertical way via a window.

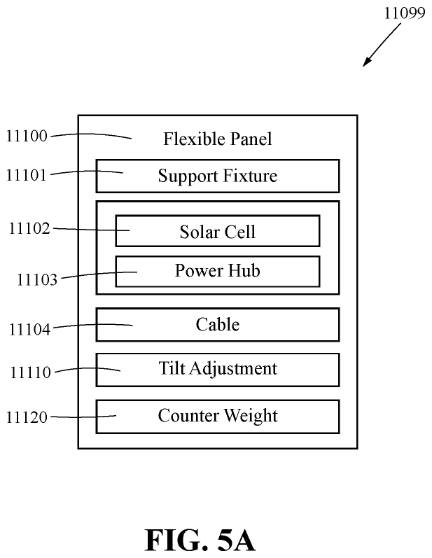

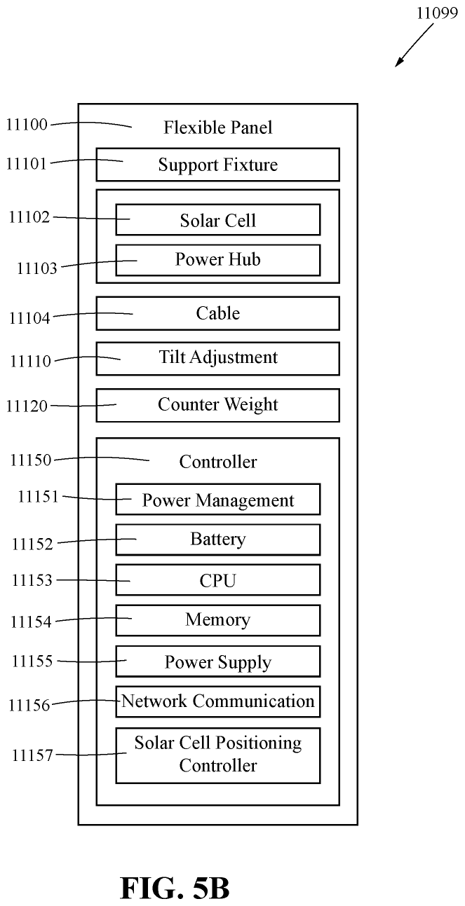

FIG. 5A shows a diagram of a flexible solar panel, generally referred to as (11099) capable of hanging from a window, from the inside or outside comprising: a flexible panel (11100) with a support fixture (11101), at least one solar cell (11102) electrically connected to a power hub (11103) that gathers the energy captured by the solar cells (11102), a cable (11104), wherein the cable (11104) is flat and flexible enough to slide through the window when the window is in the closed position. Wherein the support fixture (11101) comprises one or more of an adherent gel, a hook, a loop-and-hook mechanism and an adhesive.

In another embodiment of the technology, the solar cell (11102) comprises a tilt adjustment mechanism (11110) capable of positioning the solar cells (11102) in the direction of the sun.

In another embodiment of the technology, the flexible solar panel (11099) has a counterweight at or proximate to the lower end to keep the flexible solar apparatus straight.

One familiar with the art will appreciate that the roll down apparatus of the technology can be deployed vertically from a building from a window, terrace or rooftop on a permanent or temporary basis. This allows individuals living in building environments to use solar panels and harvest solar energy, even without direct access to a roof.

FIG. 5B shows a diagram of a flexible solar panel (11099) in another embodiment of the technology further comprising a controller (11150) comprising a power management system (11151) with a battery (11152), a central processing unit (CPU) (11153) with memory (11154), power supply (11155), network connection (11156) and a solar cell positioning controller (11157).

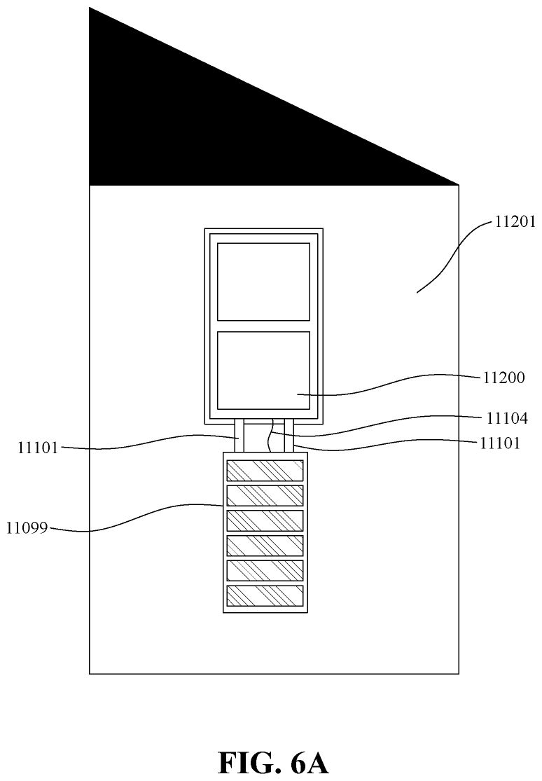

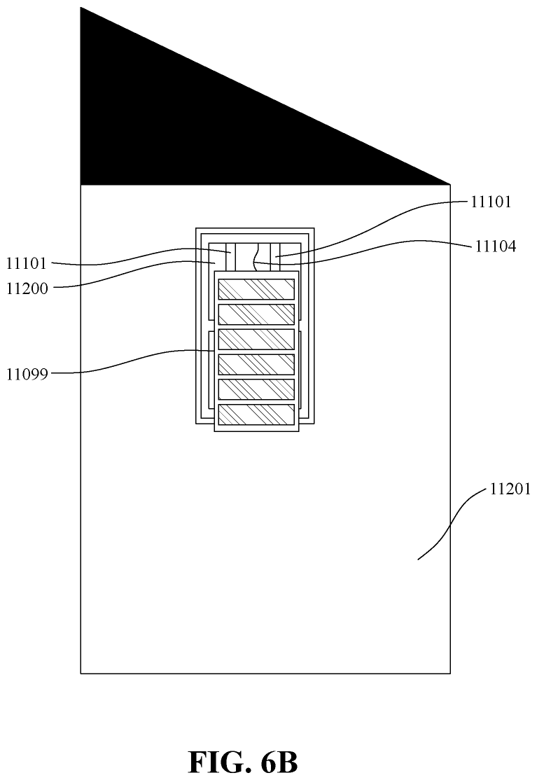

FIG. 6A shows the front view of the flexible solar panel (11099) installed outside a window (11200). This flexible solar panel (11099) allows individuals living in building settings, where there is limited or no access to the roof, to be able to capture solar energy and generate electricity. Where the flexible solar panel (11099) hangs from outside the window (11200), on the exterior surface of the building (11201), below the window (11200). Using its support fixture (11101) which comprises one or more of an adherent gel, a hook, a loop-and-hook mechanism, an adhesive, the flexible solar panel (11099) hangs in a permanent or temporary position. All the absorbed energy from the sun rays is collected and transmitted via the flat cable (11104) that extends through the window (11200) when the window (11200) is in the closed position. The collected power is then either consumed by another apparatus or fed back into the building's power grid.

FIG. 6B shows a front view of a different application of the technology where the flexible solar panel (11099) hangs from a window aperture but rests on the window itself (11200), rather than against a wall.

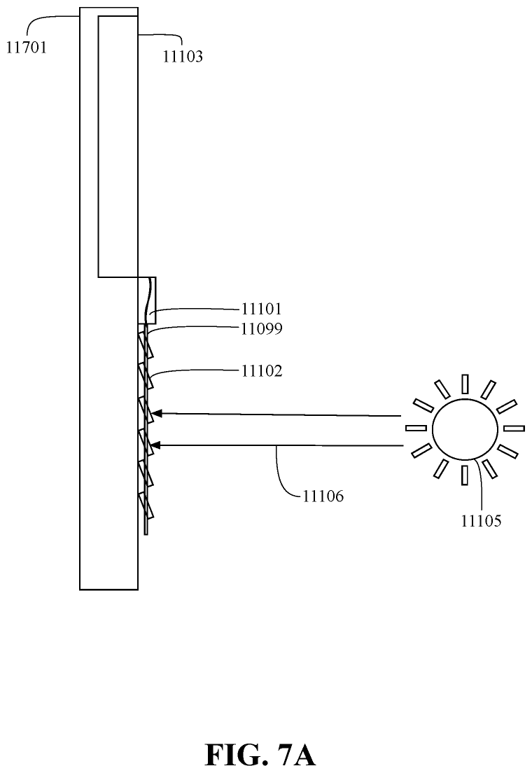

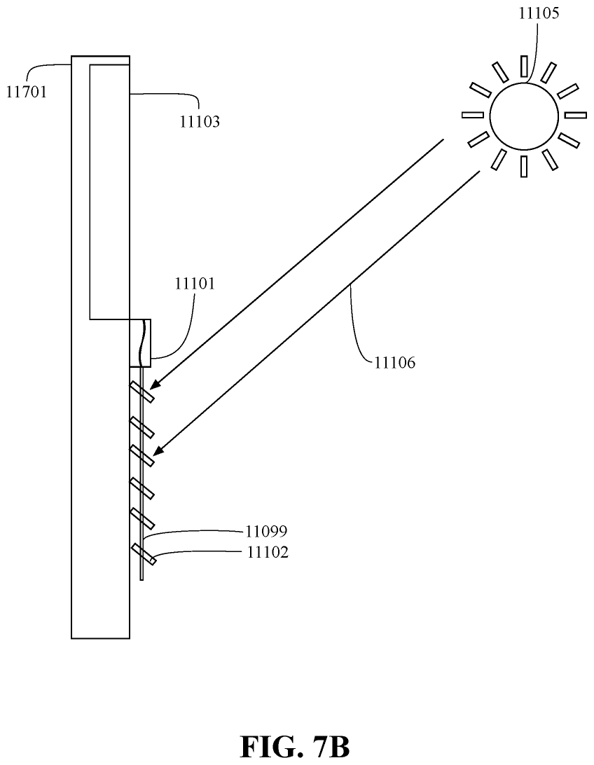

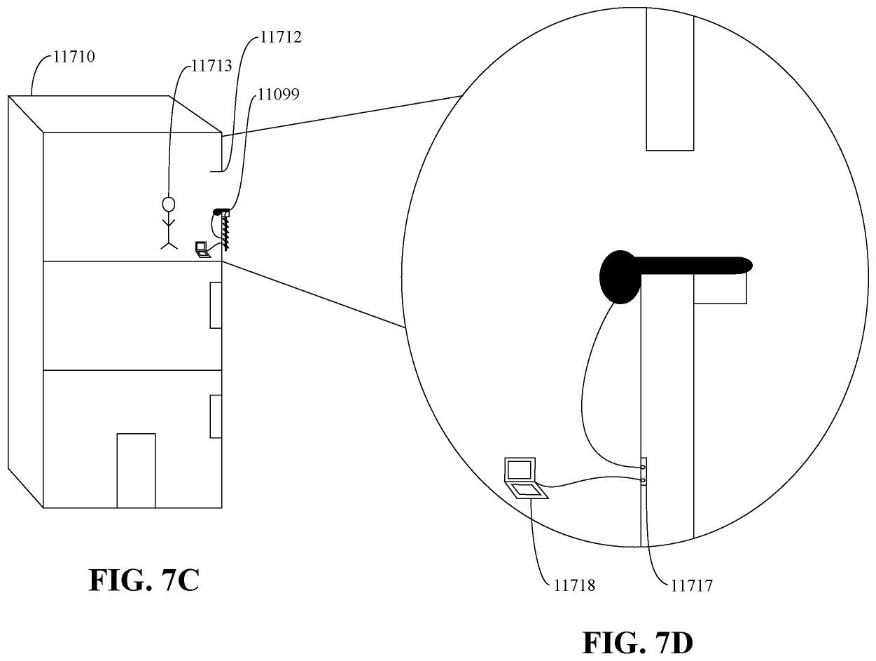

FIG. 7A shows a side view of the technology, where the flexible solar panel (11099) is hanging against the exterior of a building (11701) from a window opening (11103), with the flexible solar panel (11099) and a tilt adjustment mechanism (11101). The tilt adjustment mechanism (11101) is capable of positioning the slats comprising solar cells (11102) in the direction of the sun (11105), or as close as possible to ensure the sunrays (11106) are directly in contact with the sun (11105). In this drawing, the sun (11105) is on the horizon, for example during sunrise or sunset, and the slats are positioned to maximize the sunlight harvested. One familiar with the art will appreciate that the apparatus can be installed behind a glass or window and still collect solar energy. This technology makes it possible to collect solar energy regardless of the type of home one is in and can continue to gather energy from access to only a window or glass structure. FIG. 7B shows the same photovoltaic blind as FIG. 7A, this time the slats with solar cells (11102) are tilted facing the sun (11105) which is at a higher position than in the FIG. 7A drawing.

One familiar with the art will appreciate that most likely a user will position the flexible solar panel, that rolls down a window facing the side of the building, in the direction of where the sun is located to optimize the contact with sun rays. As the apparatus is flat and most likely it will be installed at a 90 degree angle parallel or resting in the wall, the ideal position for the solar cells may not be the 90 degree angle, but an angle looking up the sky to follow the movement of the sun.

In another embodiment of the technology, the tilt adjustment mechanism comprises a servo motor operated by the controller. One familiar with the art will appreciate that the controller may send commands to the servo motor to move to different positions throughout the day to follow the position of the sun. In another embodiment of the technology, the controller is programmable with the stages of the positioning of the sun based on the position of the apparatus in relationship with the sun. Such stages can be pre-set, pre-programmed or user programmable based on the perceived position of the sun in relation with the apparatus.

FIG. 7C shows a side view of a building (11710) with another embodiment of the technology of the flexible solar panel (11099) hanging outside a window opening (11712). This allows an individual (11713) living in apartment buildings to continue to benefit from solar energy, and through the use of this technology, continue to gather solar energy from the external environment.

FIG. 7D shows a closer look at the same embodiment of the technology of FIG. 7C. The flexible solar panel (11099) can be rolled out to hang from the window opening (11715). The solar energy collected from the solar cells (11102) on the slats (11716), is then converted to the electricity which can then be connected to a power outlet (11717), and/or used to power smart gadgets or other electronic devices, such as a laptop (11718).

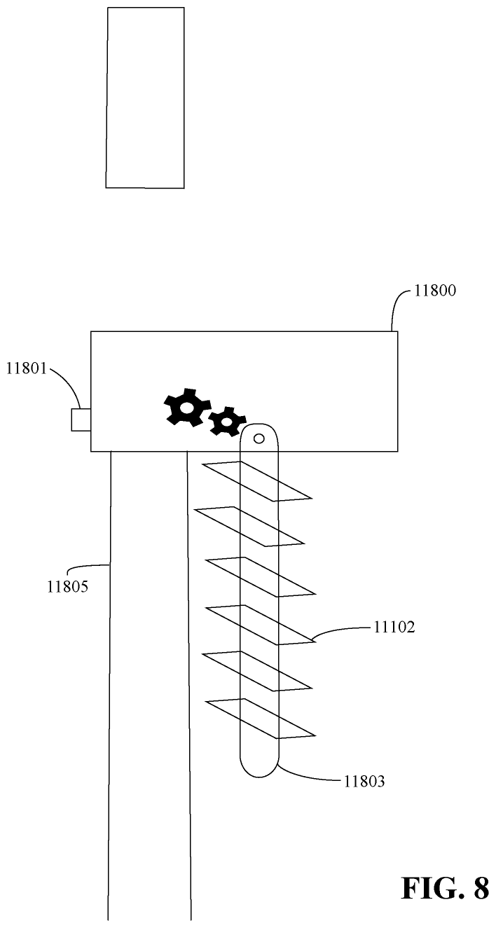

FIG. 8 shows a side view of another embodiment of the technology, where the tilt adjustment mechanism (11800) comprises a lever system operated by a knob (11801) manually operated by a user. Wherein the user can manually adjust the position of the solar cells (11102) to face as much as possible to the direction where the sun is in respect to the apparatus. In the side view drawing described in FIG. 8 the blind slats are attached to a pair of tilt levers (11803), when a user pulls one of the levers, it makes the slats to tilt to close or to open the slats. The tilt adjustment mechanism (11800) is against the exterior of a window (11805) of a building structure.

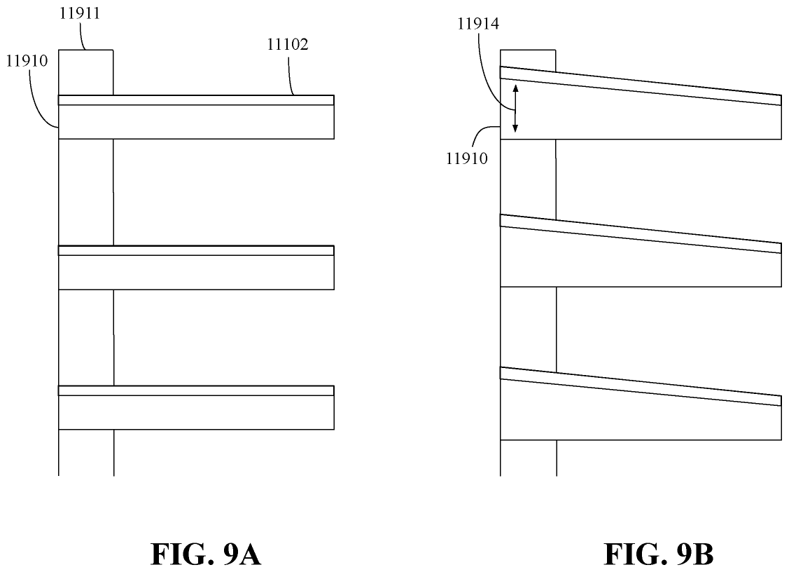

FIG. 9A shows a side view of another embodiment of the technology, where the flexible solar panel (11099) comprises an inflatable system, consisting of inflatable slats (11910) with solar cells (11102) on top. The inflatable slats are in the deflated position and are supported by the blind slats support (11911), operated by one or more from the group of a manual inflatable valve, a pneumatic motor (not shown). One familiar with the art will appreciate that pneumatically, the artifact will inflate and thus position the solar cell to face the direction of the sun. A user may inflate or deflate as required to better position the solar cells.

FIG. 9B shows the same embodiment of the technology from FIG. 9A, except the inflatable slats (11910) are in the inflated position, where the level of inflation gives different levels of tilting (11914).

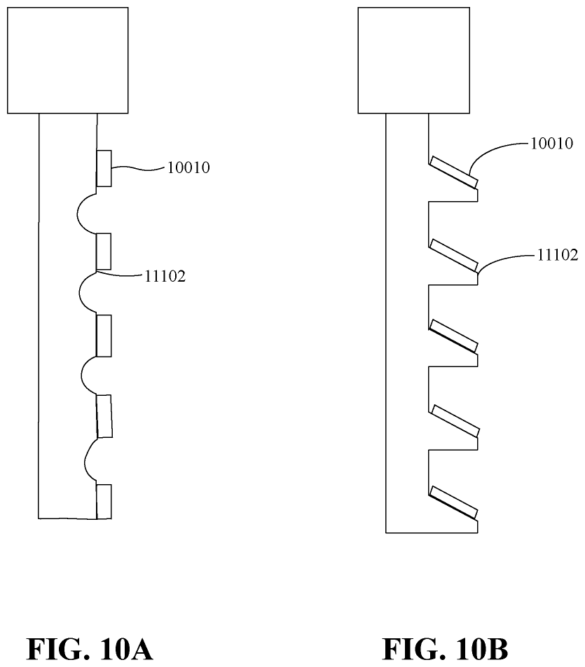

FIG. 10A and 10B show a side view of a second embodiment of the tilt adjustment mechanism that comprises an inflatable system operated by one or of a manual inflatable valve, a pneumatic motor and a hydraulic motor. FIG. 10A shows the deflated inflatable units (10010) that roll up and down with solar cells (11102) upright, directed to capture incoming sunlight from the horizontal direction. FIG. 10B shows the inflated unit (10010) that rolls up and down inflated with the solar cells (11102) at an upright tilted angle.

One familiar with the art will appreciate that when the sun is in a horizontal position with respect to the solar blind, the unit is deflated. When the sun starts rising or moving to an upper position, the solar cells follow the sun by inflating and thus tilting in the direction of the sun.

### Smart Automated Blind System

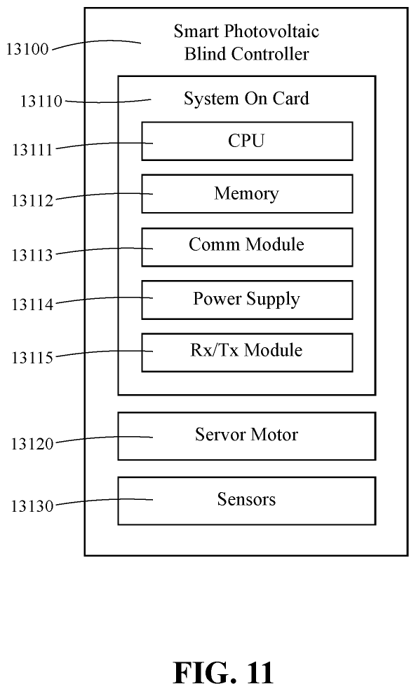

The technology is a smart photovoltaic blind system (13121) that is able to autonomously open and close based on the light and temperature of its external environment. As shown in FIG. 11, the smart photovoltaic blind system (13121) includes a blind (13000), with slats (13108), at least one solar cell (13109) on the slats (13108) and a photovoltaic blind controller (13100) which receives sensor data from sensors (13130) that detect the presence of people in the room, the location of the sun, as well as the temperature in the room, and correlates the data with a database that comprises the desired temperature inside the room. The controller (13100) sends commands to the blind (13000) to deploy and tilt or to third party peripherals like the room smart thermostat to control the temperature in combination with the deployment of the blind.

FIG. 11 shows a diagram of the smart photovoltaic blind system (13121). A controller (SPvBC)(13100) comprises a system on card (13110) comprising a CPU (13111), memory (13112), communication module (13113), and receiver transmitter module (13115). The system on a card (13110) is powered by a power supply (13114). The system on a card (13110) is in electronic communication with one or more sensors (13130) for example, but not limited to temperature sensors, photo sensors, humidity sensors, and presence sensors and in electrical communication with a servo motor (13120) that controls the opening and closing of the blinds by tilting the vertically or horizontally disposed slats (13108).

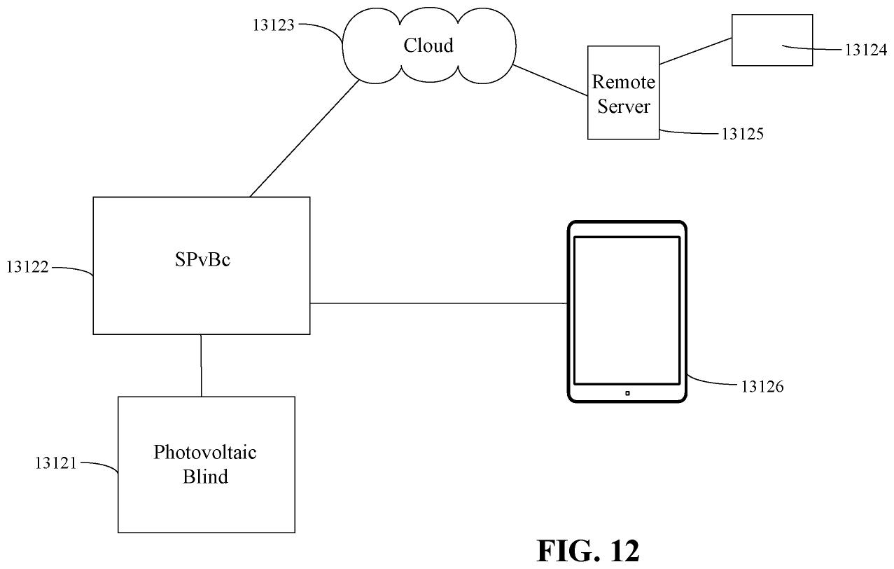

FIG. 12 is a diagram of how the smart photovoltaic blind system (13121) connects to other smart devices (13126), remote servers (13125) and databases (13124), wherein the SPvBC (13122) connects to the cloud (13123) via a communication module and from there to the remote server (13125) which comprises a database as described below. The SPvBC also connects to a smart gadget or computer, wherein a smart gadget is for example a smart watch, a smartphone, a tablet. The SPvBC is also mechanically connected to a photovoltaic blind capable of converting solar energy to electricity. In another embodiment of the technology the blind is a regular blind capable of regulating the heat and light that enters a room.

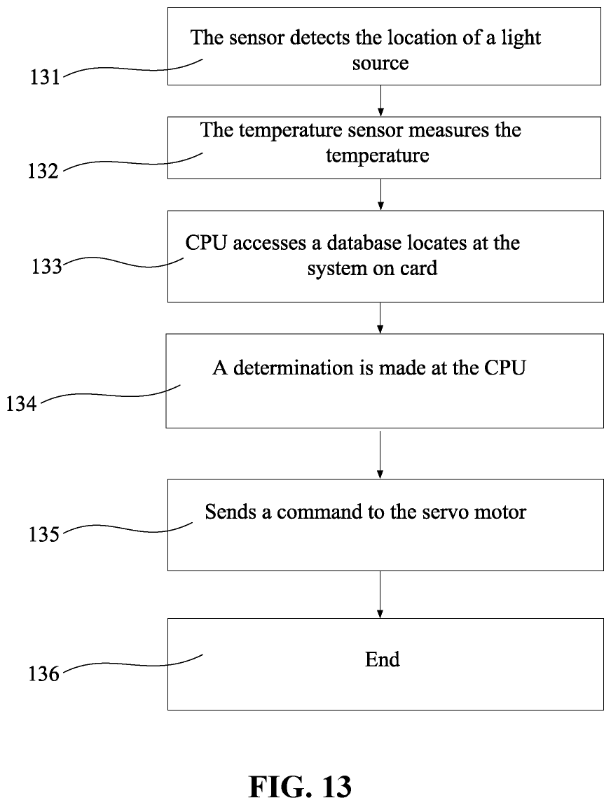

FIG. 13 is a flow chart describing the functioning of the smart automated blind system (13121):
Step 131—the sensor detects the location of a light source, wherein the light source is one from the group of the sun, a lamp, a reflection of a heat source such as a reflection of the sun.
Step 132—the temperature sensor or thermometer measures the temperature inside a first room where the apparatus is located, recording this temperature as a temperature reading.
Step 133—the CPU has access to a database located at the system on card or in a remote server. Wherein the database comprises the desired internal temperature range for the first room.
Step 134—a determination is made, at the CPU, that the temperature reading of the room is outside the desired internal temperature range selected for the first room.
Step 135—Sending a command to the servo motors to adjust the deployment or tilting of the blind.

One familiar with the art will appreciate that the apparatus identifies that the room is above the desired average for sunlight and heat, then sends the shades to a “closed position” to collect energy and provide shade.

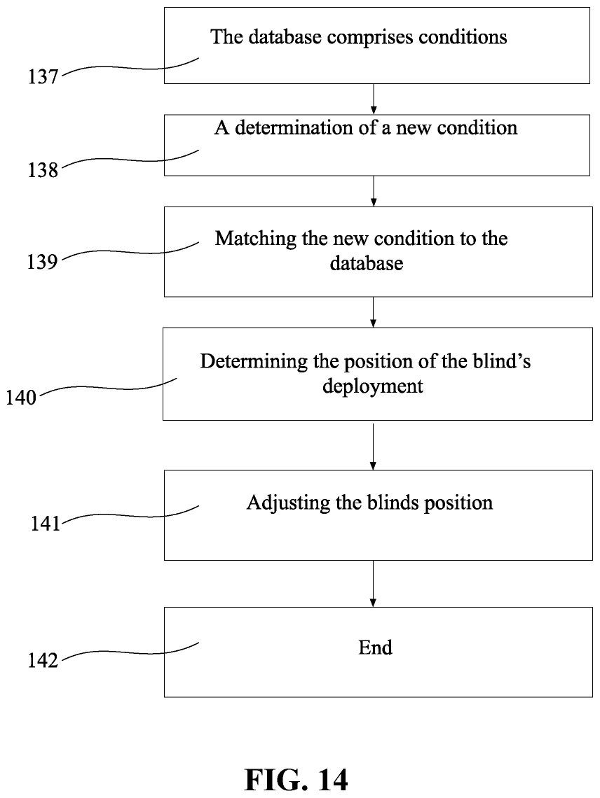

FIG. 14 is a flowchart describing a secondary embodiment of the technology:
Step 137—the database comprises conditions, wherein the conditions include different scenarios depending on internal temperature, external temperature, location of the light or heat source, presence of persons, reading from the first room thermostat.
Step 138—a determination of a new condition, by the presence sensor, that a person is present in the room.
Step 139—matching the new condition to the database.
Step 140—determine the position of the blind's deployment.
Step 141—adjusting the blinds position to match the required selection. For example, tilting the blinds based on the status of the room thermostat and the presence of people in the first room.

### Removable Retractable Photovoltaic Blind that Adheres to Glass

The present technology is a retractable photovoltaic blind that adheres to a window's surface while the photovoltaic blind is deployed and detaches from the window's surface when it is retracted. In a first embodiment of the technology, the retractable photovoltaic blind is coated with a removable and/or reusable pressure-sensitive adhesive. In a second embodiment of the technology the retractable photovoltaic blind uses electrostatic force to adhere to the window's surface.

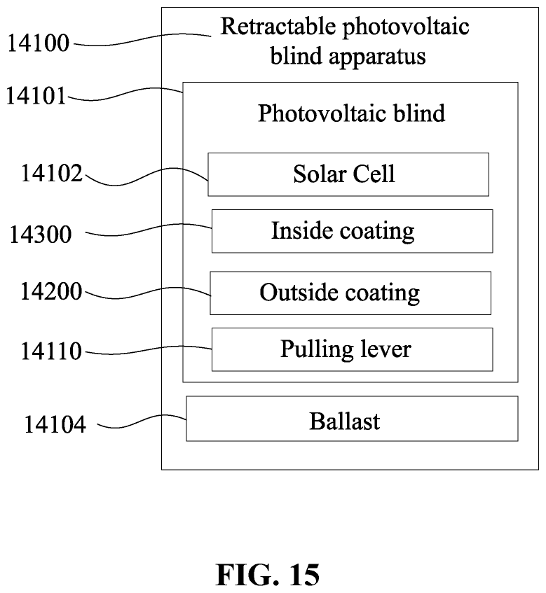

FIG. 15 shows a diagram of a retractable photovoltaic blind apparatus (14100) comprising a photovoltaic blind (14101) which comprises at least one opaque, translucent or transparent solar cell (14102); wherein the solar cell (14102) faces to the outside position of the photovoltaic blind (14101). Wherein the photovoltaic blind (14101) rolls in a ballast (14104), wherein the ballast installs on one from the group of the upper portion of a window, the lower portion of the window, the side of a window.

Continuing on the description of FIG. 15, the retractable photovoltaic blind apparatus (14100) also comprises a first pulling lever (14110). An outside coating (14200) of the photovoltaic blind shade, and optionally an inside coating (14300) of the photovoltaic blind shade as described in the figures below.

In one embodiment of the technology the photovoltaic blind (14101) is flexible. In another embodiments of the technology, the photovoltaic blind (14101) is rigid.

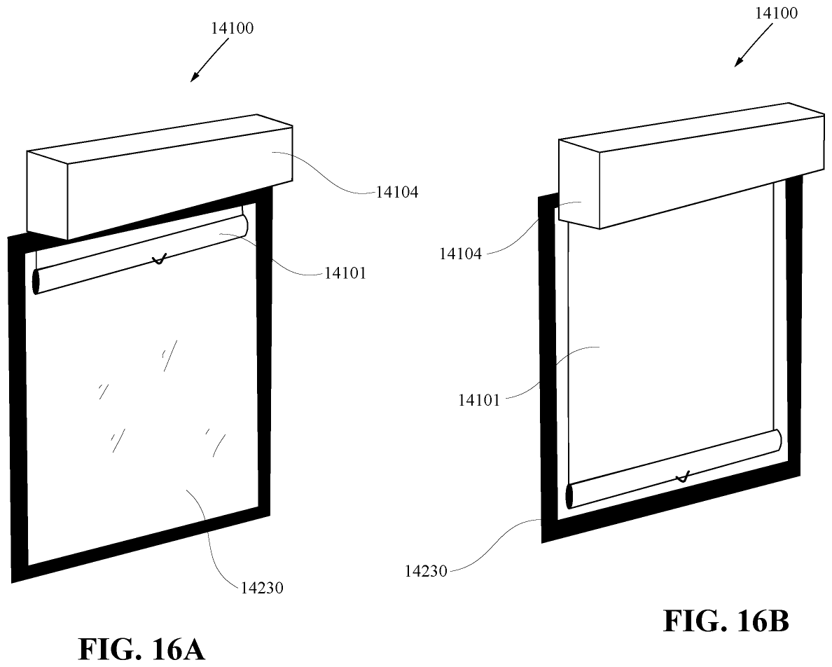

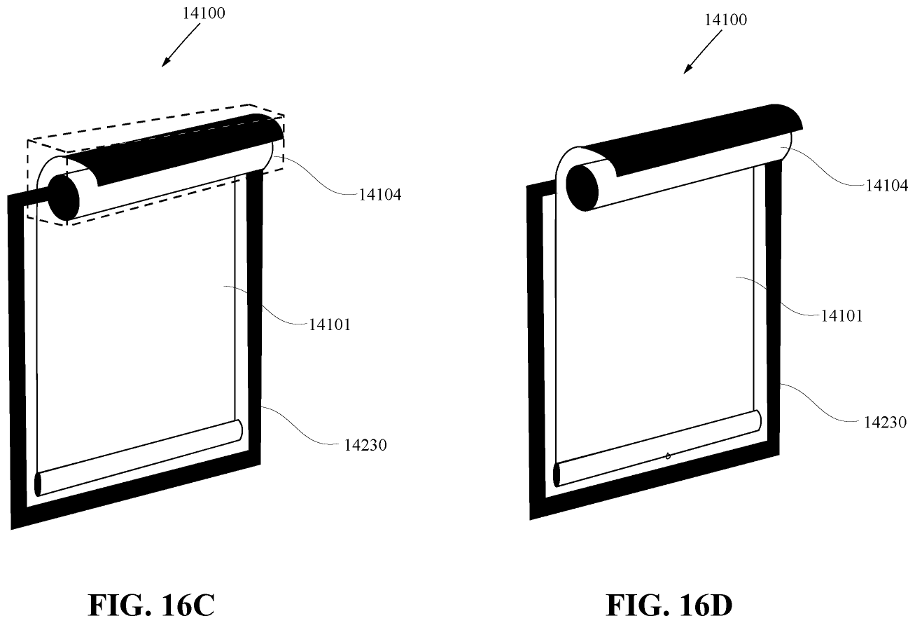

FIG. 16A shows a side perspective view of the photovoltaic blind (14101) in the retracted position allowing the sun rays to go through the window (14230), thus, in the daytime allowing the rays to illuminate the interior of the space, be it for example a home, a room, an office. One familiar with the art will appreciate that by allowing the sun rays through, it is not only light that makes it through the window (14230) but also heat. This may contribute, for example, to energy savings or cost increase in the heating or air conditioning of the room where the window (14230) is located.

FIG. 16B shows a side perspective view of the retractable photovoltaic blind system (14100) with the photovoltaic blind (14101) deployed covering the window (14230) i.e. when the photovoltaic blind (14101) is deployed, the sun rays are absorbed and transformed into energy and at the same time, for example, the room is made less bright and reduces solar heating.

FIG. 16C and 16D show a side perspective view of the retractable photovoltaic blind apparatus (14100) wherein the photovoltaic blind (14101), rolls out of the ballast (14104) and is deployed covering the window's surface (14230).

One familiar with the art will appreciate that depending on the light diffraction coefficient of the window's surface, for example glass, as the photovoltaic blind shade goes farther from the glass it may lose light intensity. Smaller gaps between solar panels and the window's surface are more favourable for the collection of the solar rays.

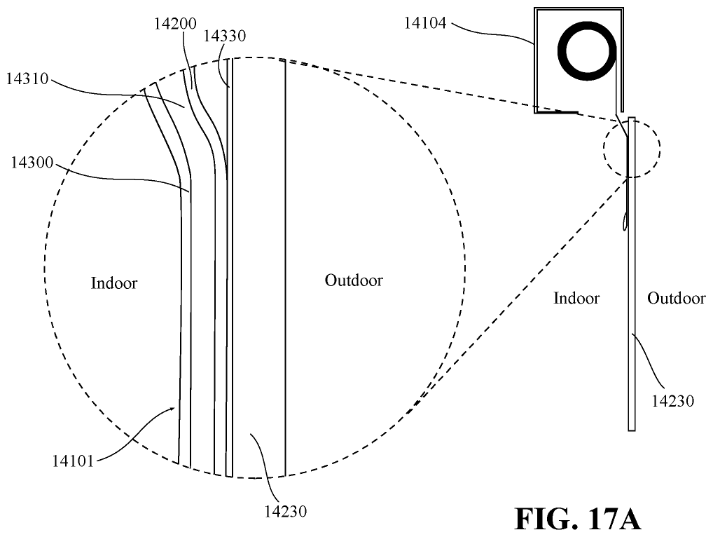

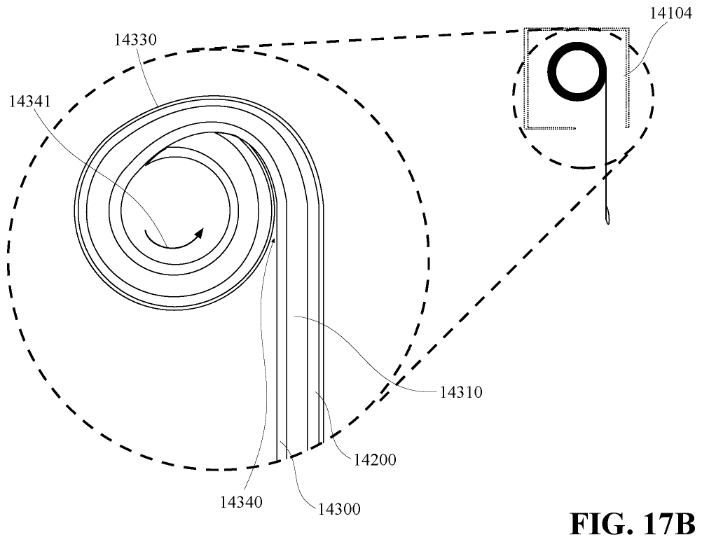

FIGS. 17A and 17B show a side close up view of the photovoltaic blind (14101), wherein its core comprises a solar cell stack (14310) comprising solar cells made of silicon or perovskites to name a few, covered by transparent or translucent electrodes. In a first embodiment of the technology where the outside surface (14200) of the photovoltaic blind (14101) comprises a coating made from one or more from a pliable, flexible and light-weight, yet durable and tear-resistant sheet of material. Examples of said material include, but are not limited to: films (e.g., polyester, polyethylene, polyurethane, polypropylene, polytetrafluorethylene (PTFE), vinyl, etc.), foams (e.g., acrylic, polyethylene, urethane, neoprene, etc.), foils (e.g., aluminum, copper, lead, stainless steel, etc.), cloths (e.g., cotton, polyester, acetate, nylon, rayon, etc.), rubbers (e.g., silicone, neoprene, ethylene propylene diene monomer, other natural and/or synthetic elastomers, etc.), or a combination thereof. The coating (14200) is coated with a removable and/or reusable pressure-sensitive acrylic, rubber, or silicone-based adhesive (14330). The removable and/or reusable adhesive may facilitate the temporary attachment of the outside surface [coating] (14200) and thus the photovoltaic blind (14101), to the window's surface (14230).

Continuing with the description of FIG. 17A, the inside surface (14300) is made from one or more from the group of may be a pliable and light-weight, yet durable and tear-resistant sheet of material. Examples of said material include, but are not limited to: films (e.g., polyester, polyethylene, polyurethane, polypropylene, polytetrafluorethylene (PTFE), vinyl, etc.), foams (e.g., acrylic, polyethylene, urethane, neoprene, etc.), cloths (e.g., cotton, polyester, acetate, nylon, rayon, etc.), rubbers (e.g., silicone, neoprene, ethylene propylene diene monomer (EPDM), other natural and/or synthetic elastomers, etc.), or a combination thereof; wherein, as shown in FIG. 17B, the inside coating (14300) repels (14340) the removable and/or reusable adhesive of the outside coating (14200), thus, allowing it to roll (14341) and unroll from inside the ballast (14104).

In a second embodiment of the technology, the adhesive coating is an optically clear layer coated on the window glass. As the photovoltaic blind (14101) unfolds from the roller, there is a mm size gap between the unrolled blind and the adhesive layer on the window.

An automated roller then presses the blind (14101) to the window by moving from top to bottom and bottom to top, creating a close contact between the blind (14101) and window.

In a third embodiment of the technology, window glasses are wiped by chemicals to create a nm-size coating of chemicals containing polar molecules and particles. The polar molecules and particles will create a chemical bond with the outside layer of the blind (14101). As the blind (14101) unrolled there is a mm-size gap between the blind (14101) and window glass, now treated with bonding materials. An automated roller then presses the blind to the window by moving from top to bottom and bottom to top, creating a close contact between the blind (14101) and window.

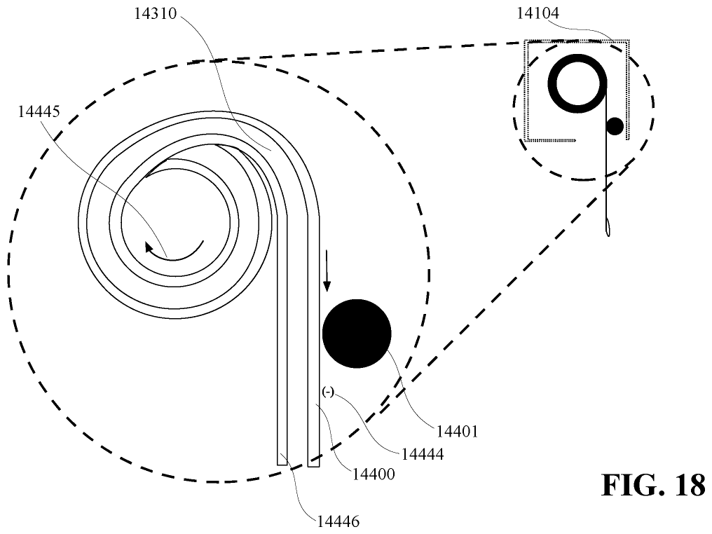

FIG. 18 shows a side close up view of a second embodiment of the technology where the coating in the outside surface (14400) can be induced with static charge as a coating is applied to the outside surface (14400) of the photovoltaic blind (14101), wherein the coating is made from one or more from the group of films, foams, foils, cloths, rubbers. In another embodiment of the technology the outside surface is coated with polymers with or without crystals and/or ceramics molecules.

A static charge inducer (14401) installed inside the ballast (14104), wherein the static charge inducer polarizes or induces charges on the outside surface's (14400) material of the photovoltaic blind (14101). Wherein the static inducer charge separation comprises one or more from the group of contact-induced, pressure-induced, heat-induced, charge-induced. A person familiar with the art will appreciate that the phenomenon of static electricity requires a separation of positive and negative charges. When two materials are in contact, electrons may move from one material to the other, which leaves an excess of positive charge on one material, and an equal negative charge on the other. When the materials are separated they retain this charge imbalance.

When the photovoltaic blind's (14101) outside coating material (14400) unrolls (14445) and passes through the static inducer (14401) and the charge (14444) on the outside coating material (14400) is separated. By static forces it temporarily adheres to a window's surface (not shown) to minimize the disruption and reduction of the sun rays that pass through the glass and make it to the solar cell stack (14310). In another embodiment of the technology, the solar cell stack (14310) comprises an inside surface coating (14446) that repels any static stored in the outside coating material (14400). A person familiar with the art will appreciate that an efficient way to prevent electrostatic discharge is to use materials that are not too conductive but will slowly conduct static charges away.

Materials are made of atoms that are normally electrically neutral because they contain equal numbers of positive charges (protons in their nuclei) and negative charges (electrons in “shells” surrounding the nucleus). The phenomenon of static electricity requires a separation of positive and negative charges. When two materials are in contact, electrons may move from one material to the other, which leaves an excess of positive charge on one material, and an equal negative charge on the other. When the materials are separated they retain this charge imbalance. Different types of charge separation processes include for example, but not limited: contact-induced, pressure-induced, heat-induced, charge-induced.

Contact-induced charge separation-The triboelectric effect causes an electrostatic charge to build up on the outside coating surface (14400) of the photovoltaic blind (14101) due to the contact of the outside coating surface (14400) with the inducer (14401). The electric field of the charge causes polarization of the molecules of the outside coating surface (14400) due to electrostatic induction, resulting in a slight attraction of the glass or plastic (14230) to the charged outside coating surface (14400) of the photovoltaic blind shade (14101).

Electrons can be exchanged between materials on contact; materials with weakly bound electrons tend to lose them while materials with sparsely filled outer shells tend to gain them. This is known as the triboelectric effect and results in one material becoming positively charged and the other negatively charged. The polarity and strength of the charge on a material once they are separated depends on their relative positions in the triboelectric series. The triboelectric effect is the main cause of static electricity as observed in everyday life, and in common high-school science demonstrations involving rubbing different materials together (e.g., fur against an acrylic rod). Contact-induced charge separation causes hair to stand up and causes “static cling” (for example, a plastic film rubbed against the hair becomes negatively charged; when near a window, the charged film is attracted to positively charged particles in the window and can “cling” to it.

Pressure-induced charge separation—Applied mechanical stress generates a separation of charge in certain types of crystals and ceramics molecules.

Heat-induced charge separation—Heating generates a separation of charge in the atoms or molecules of certain materials. All pyroelectric materials are also piezoelectric. The atomic or molecular properties of heat and pressure response are closely related.

Charge-induced charge separation—A charged object brought close to an electrically neutral object causes a separation of charge within the neutral object. Charges of the same polarity are repelled and charges of the opposite polarity are attracted. As the force due to the interaction of electric charges falls off rapidly with increasing distance, the effect of the closer (opposite polarity) charges is greater and the two objects feel a force of attraction. The effect is most pronounced when the neutral object is an electrical conductor as the charges are freer move around. Careful grounding of part of an object with a charge-induced charge separation can permanently add or remove electrons, leaving the object with a global, permanent charge. This process is integral to the workings of the Van de Graaff generator, a device commonly used to demonstrate the effects of static electricity.

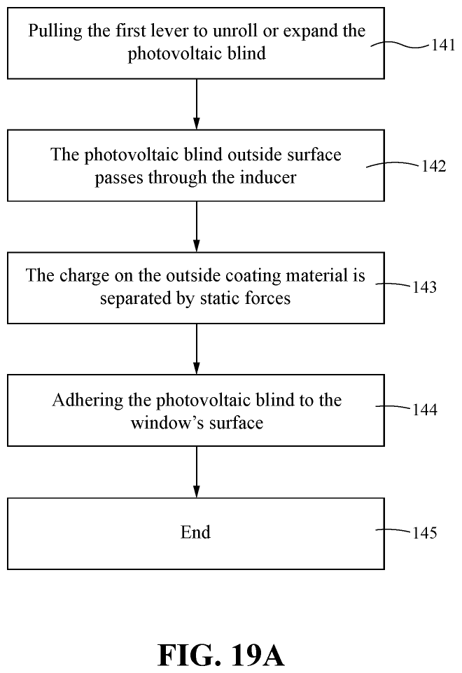

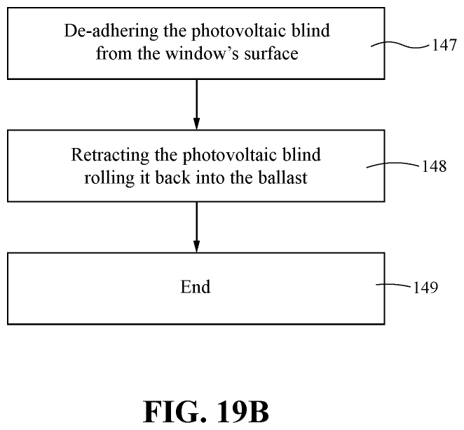

FIG. 19A is a flowchart describing the method for the operation of the retractable photovoltaic blind system (14100) using the static charge option with the static inducer (14401).

Step 141—a first deployment action comprising pulling the first lever to unroll or expand the photovoltaic blind to the desired area to cover the window's surface, whereby the photovoltaic blind's outside surface is charged with positive or negative ions by the static inducer. One familiar with the art will appreciate that the window's surface can be made of glass or other materials such as plastics that are transparent or translucent and that can be covered in one or both sides with films or tinted.

Step 142—the photovoltaic blind's outside surface passes through the inducer.

Step 143—the charge on the outside coating material is separated, by static forces-When the photovoltaic blind's outside coating material unrolls from the ballast (14104) and passes through the static inducer, the charge on the outside coating material is separated, by static forces permitting it to temporarily adhere to the window's surface.

Step 144—a second deployment action comprising adhering the photovoltaic blind to the window's surface.

FIG. 19B is a flowchart describing a method, continuation of the method described in FIG. 19A, describing how to release the photovoltaic blind.

Step 147—a first removal action comprising de-adhering the photovoltaic blind from the window's surface. For example, when the user doesn't want to open the blinds to see through the window or to let the sun rays in, the user may want to retract the photovoltaic blind, but first the user must separate the photovoltaic blind from the window's surface. Once it is separated, they may proceed to the next step.

Step 148—a second removal action comprising retracting the photovoltaic blind (14101) rolling it back into the ballast (14104). Continuing with the example from the previous step, the user, after separating the photovoltaic blind shade from the window's surface, may retract it to have the window clear of any blinds (14101) blocking the window (i.e. to be able to see outside or to let the sun rays in).

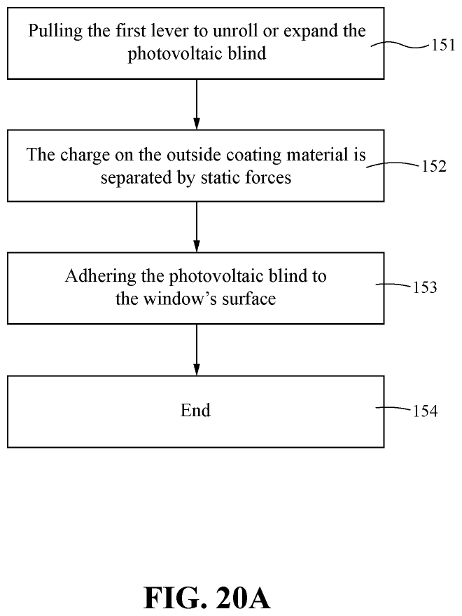

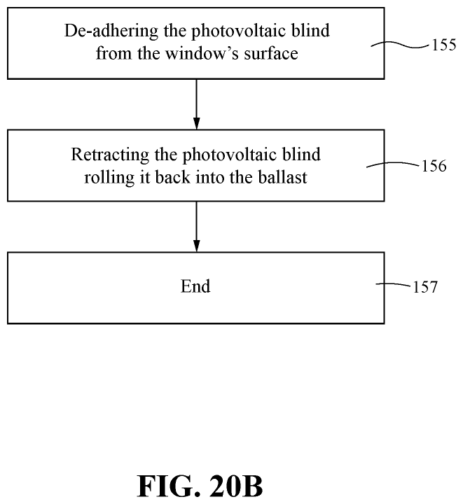

FIG. 20A is a flowchart of another embodiment of the technology describing the method for the operation of the retractable photovoltaic blind system using the static charge option without an inducer in the ballast (14104), but by using a material in the photovoltaic blind's (14101) inside coating that separates the charges the material in the outside surface creating a static force that helps the photovoltaic blind (14101) to adhere to the window's surface.

Step 151—a first deployment action comprising pulling the first lever to unroll or expand the photovoltaic blind (14101) to the desired area to cover the window's surface, whereby the photovoltaic blind's (14101) outside surface charged is separated by the contact of the outside surface with the inside surface when rolled out. One familiar with the art will appreciate that the window's surface can be made of glass or other materials such as plastics that are transparent or translucent and that can be covered in one or both sides with films or tinted.

Step 152—the charge on the outside coating material is separated, by static forces-When the photovoltaic blind's (14101) outside coating material unrolls and separates from the inside surface, the charge on the outside coating material is separated, by static forces permitting it to temporarily adhere to the window's surface.

Step 153—a second deployment action comprising adhering the photovoltaic blind (14101) to the window's surface.

FIG. 20B is a flowchart describing a method, continuation of the method described in FIG. 20A, describing how to release the photovoltaic blind (14101).

Step 155—a first removal action comprising de-adhering the photovoltaic blind (14101) from the window's surface. For example, when the user doesn't want to open the blinds (14101) to see through the window or to let the sun rays in, the user may want to retract the photovoltaic blind (14101), but first the user must separate the photovoltaic blind (14101) from the window's surface. Once it is separated, they may proceed to the next step.

Step 156—a second removal action comprising retracting the photovoltaic blind (14101) rolling it back into the ballast (14104). Continuing with the example from the previous step, the user, after separating the photovoltaic blind (14101) from the window's surface, may retract it to have the window clear of any blinds blocking the window (i.e. to be able to see outside or to let the sun rays in).

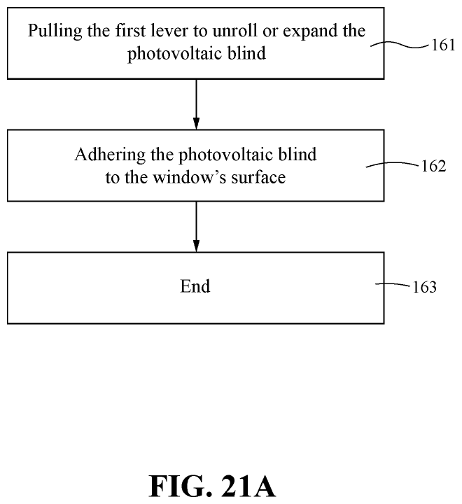

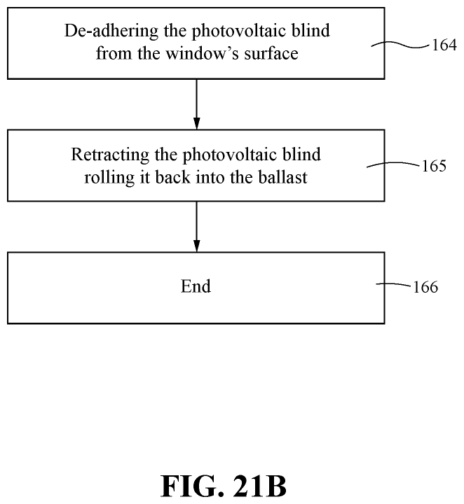

FIG. 21A is a flowchart describing another embodiment of the method for the operation of the photovoltaic blind (14101) using the adherent by material feature.

Step 161—a first deployment action comprising pulling the first lever to unroll or expand the photovoltaic blind (14101) to the desired area to cover the window's glass.

Step 162—a second deployment action comprising adhering the photovoltaic blind (14101) to the window's surface. The adhesion action may include a pressure sensitive action, where in order for the photovoltaic blind shade to adhere to the window's surface, someone may need to apply pressure. In another embodiment of the technology, the ambient static force may cause the photovoltaic blind (14101) to be attracted to the window's surface and the adherent may temporarily adhere the photovoltaic blind (14101) to the window's surface.

FIG. 21B is a flowchart describing a method, continuation of the method described in FIG. 21A about the release of the photovoltaic blind (14101).

Step 164—a first removal action comprising de-adhering the photovoltaic blind (14101) from the window's surface.

Step 165—a second removal action comprising retracting the photovoltaic blind (14101) by rolling it back into the ballast (14104).

### Photovoltaic Window Covering Strip that Fills the Gap between a Photovoltaic Blind and a Window'S Frame

A photovoltaic window covering strip apparatus that covers an area on a window which is not covered by a photovoltaic blind, usually between the photovoltaic blind and a window frame. The photovoltaic window covering strip captures sun rays and converts it to usable energy.

In another embodiment of the technology, the apparatus connects to a photovoltaic blind as a peripheral component.

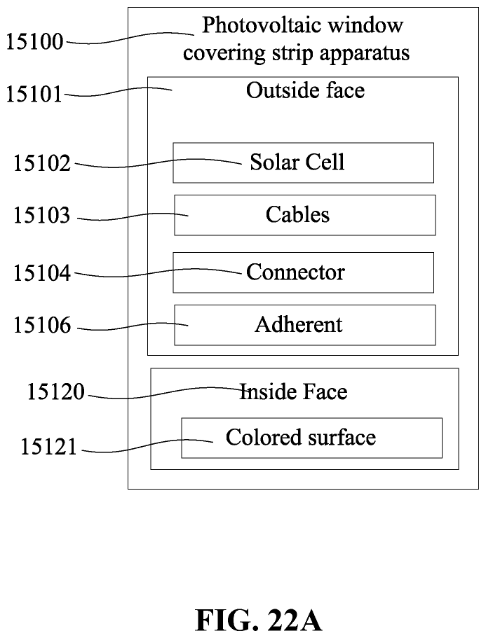

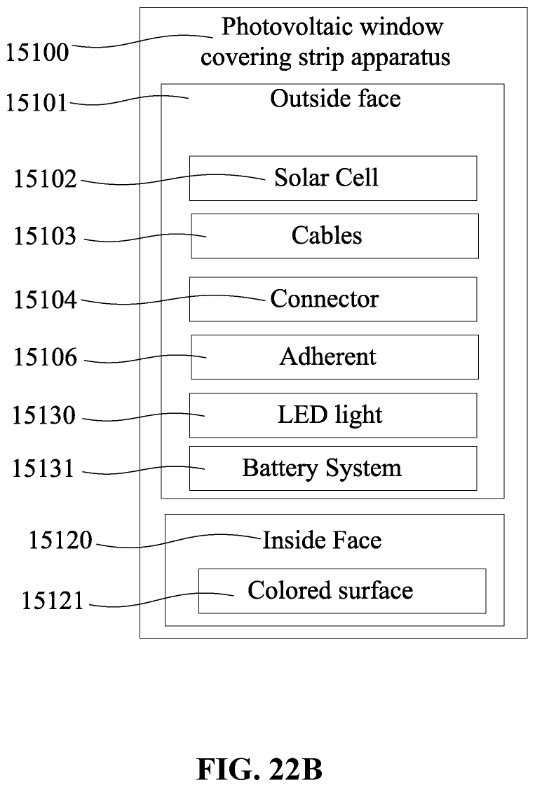

FIG. 22A is a diagram of the components in the photovoltaic window covering strip (15100), which comprises an outside face (15101) comprising a solar cell (15102) or multiple solar cells, wherein the solar cell is mechanically connected with a cable or cables (15103) to a connector (15104), which is at one end of the photovoltaic window covering strip (15100), wherein the connector connects to a photovoltaic blind; the outside face also comprises an adherent (15106) that fixes the photovoltaic window covering strip (15100) to a window. In another embodiment of the technology the adherent is an adhesive of one or more, but not limited to the group of removable and/or reusable pressure-sensitive acrylic, rubber, or silicone-based adhesive.

Continuing with the description of the components of a photovoltaic window covering strip (15100), its inside face (15120) comprises a colored surface (15121), which further comprises one or more from the group of films, foams, cloths, rubbers or other similar material. One familiar with the art will appreciate that the colored surface is the side facing the inside of the building, as such, it could be a color matching the color of the window frame, wall or other decorative aspects of the building. In another embodiment of the technology, the inside face of the photovoltaic window covering strip apparatus further comprises one or more from the group of films, foams, foils, cloths, rubbers or other similar material, wherein the outside face is coated with a material capable of repelling dust.

In another embodiment of the technology, the photovoltaic window covering strip is one from the group of flexible, semi-flexible, rigid materials, photovoltaic materials.

FIG. 22B shows a diagram of components with another embodiment of the technology wherein the photovoltaic window covering strip (15100) further comprises an LED light (15130) installed on the outside face (15101). One familiar with the art will appreciate that the energy captured by the photovoltaic window covering strip (15100) can be used to light an LED at night. One familiar with the art will appreciate that the LED light can be any type of low energy consumption type of light generating component such as OLED or similar to name a few.

In another embodiment of the technology, the photovoltaic window covering strip (15100) further comprises a battery system (15131) that stores the solar energy converted to usable energy captured by the solar cells in the photovoltaic window covering strip apparatus. One familiar with the art will appreciate that the photovoltaic window covering strip (15100) could work as a stand-alone unit being independent from the photovoltaic blind and just capture energy by day and use it to power the built-in LED light by night.

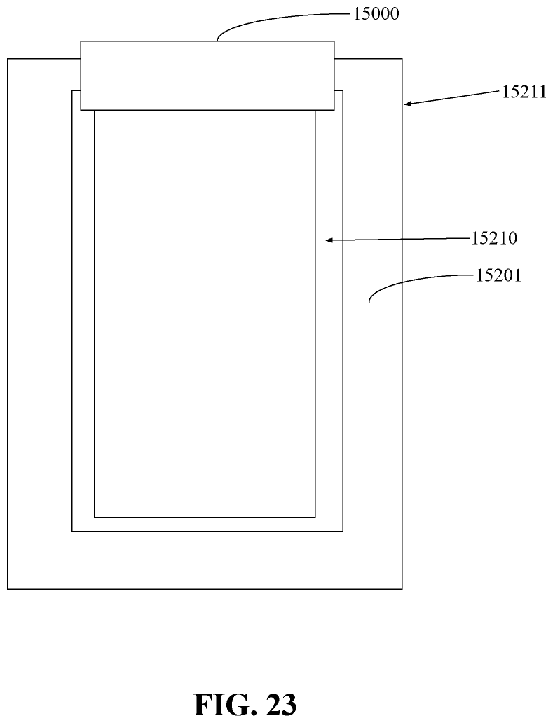

FIG. 23 is a front view of a photovoltaic blind (15000) installed in a window (15211). Showing how in some instances, the width area to cover the space between the photovoltaic blind and the frame of the window (15210) might have a gap (15201). One familiar with the art will appreciate that when installing a photovoltaic blind (15000) it may come in standard width sizes and as such, the width of the photovoltaic blind may not cover the width of the window. As such, the gap (15201) must be covered in order to save solar energy/heat from entering or exiting the building.

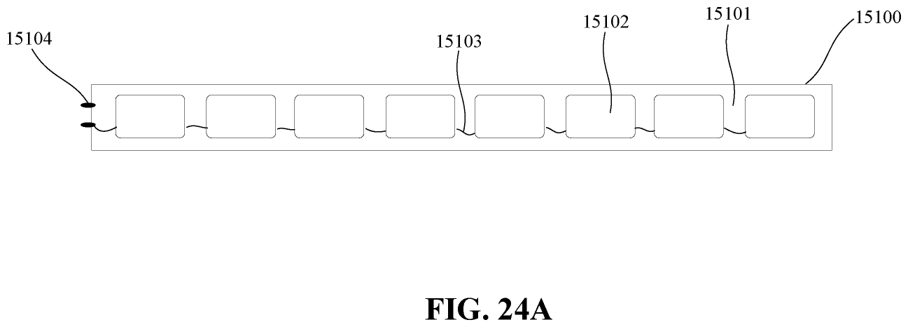

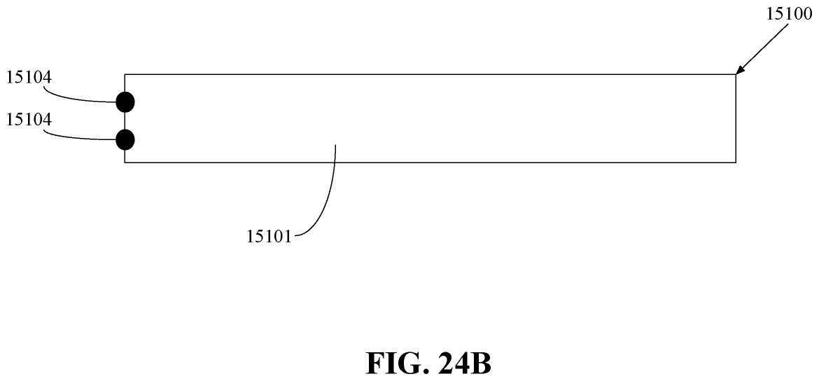

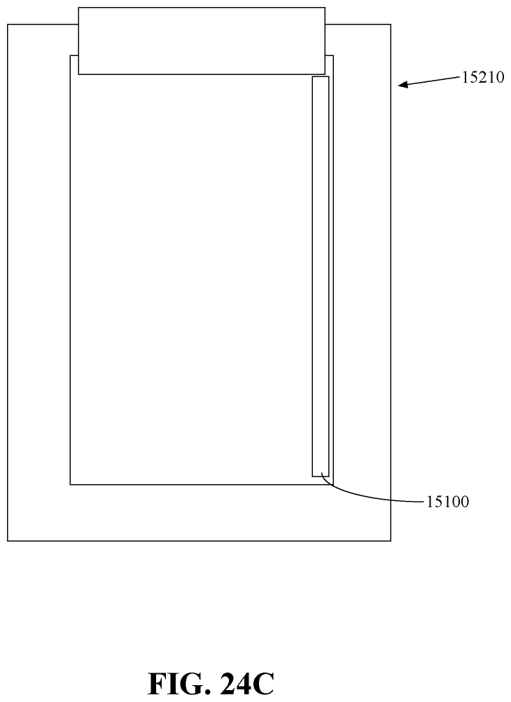

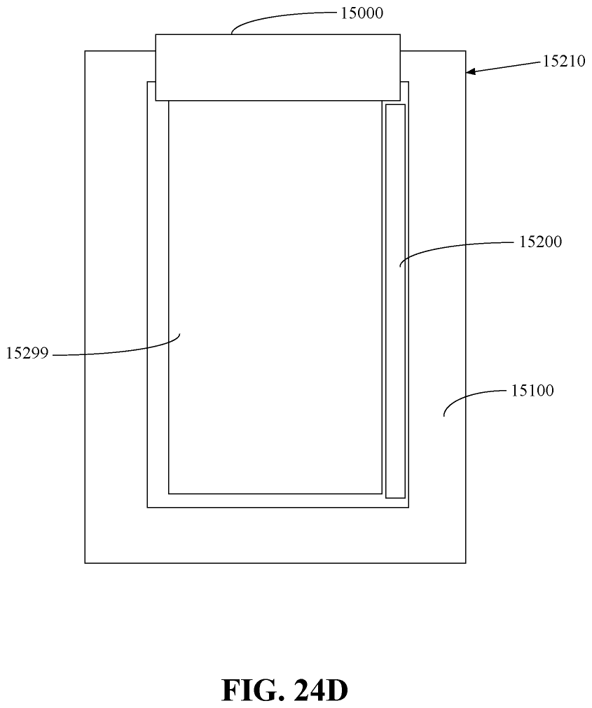

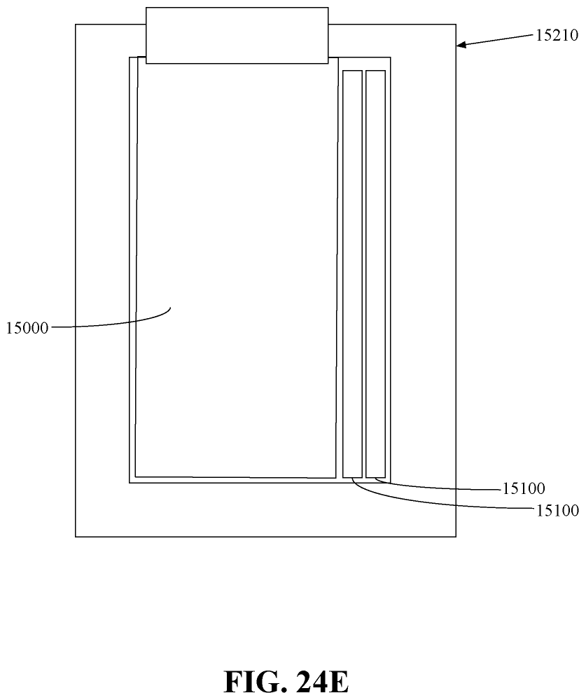

FIG. 24A is a front view of the photovoltaic window covering strip (15100). It shows the outside face (15101) which includes the solar cells (15102), the drawing also shows the connecting cables (15103) which may be inside the material or behind the solar cells (15102) or between the solar cells (15102) and the blind material (not shown). It also shows the connectors (15104) which connect the apparatus to a photovoltaic blind (not shown).

FIG. 24B is a back view of the photovoltaic window covering strip (15100). It shows the inside face (15101) and the connectors (15104).

FIG. 24C is a front view of the photovoltaic window covering strip (15100) installed in a window (15210). It shows how the photovoltaic window covering strip (15100) is installed covering an area that the photovoltaic blind (not shown) may not cover.

FIG. 24D is a front view of the photovoltaic window covering strip (15100) installed in a window (15210) with a photovoltaic blind (15000) deployed. As shown, the photovoltaic window covering strip apparatus (15100) covers the gap (15201) left by the photovoltaic blind (15000) between it and the window's frame (15210).

FIG. 24E is a front view of a side-by-side installation of a couple of photovoltaic window covering strip (15100) installed in a window (15210). One familiar with the art will appreciate that in some instances, the width area to cover the space between the photovoltaic blind (15000) and the frame of the window (15210) might be larger than the width of a single photovoltaic window covering strip apparatus, thus, a couple or more side-by-side photovoltaic window covering strip apparatus might be needed.

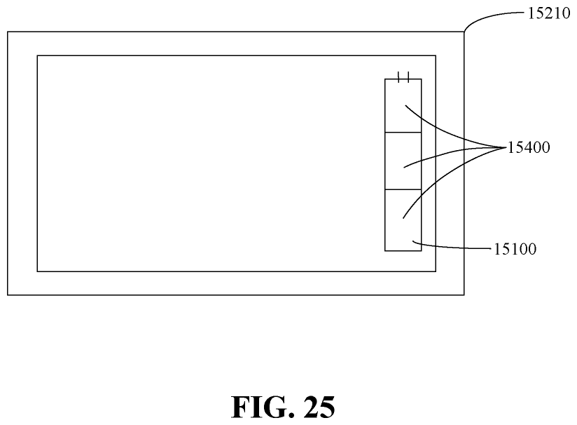

FIG. 25 shows a front view of another embodiment of the technology showing the photovoltaic window covering strip (15100) divided in sections (15400), wherein a section can be spliced from the rest of the photovoltaic window covering strip (15100) to make it fit the height or width of the window (15210).

### Share Energy Storage Between Two or More Photovoltaic Collectors

This photovoltaic device has energy storage capability that shares its space with other photovoltaic devices connected to the same grid that communicate between the devices using a common network.

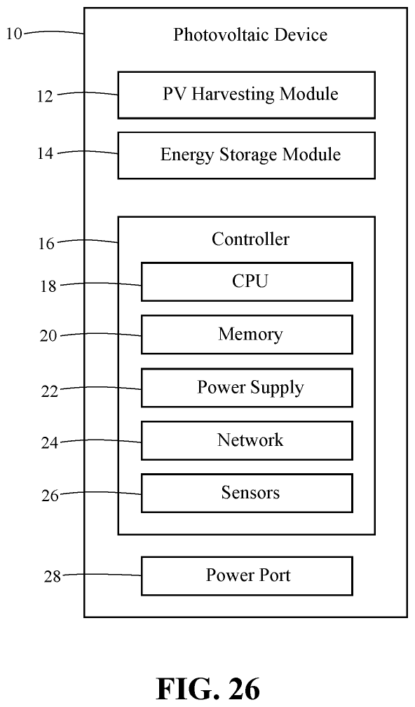

FIG. 26 is a block diagram of a photovoltaic device 10 comprising a photovoltaic energy harvesting module 12, an energy storage module 14, a controller 16 comprising a CPU 18, memory 20, a power supply 22, wired and wireless network capabilities 24, one or more sensors 26 from the group of photosensors, weather, temperature, energy use and distribution, energy input and output ports 28

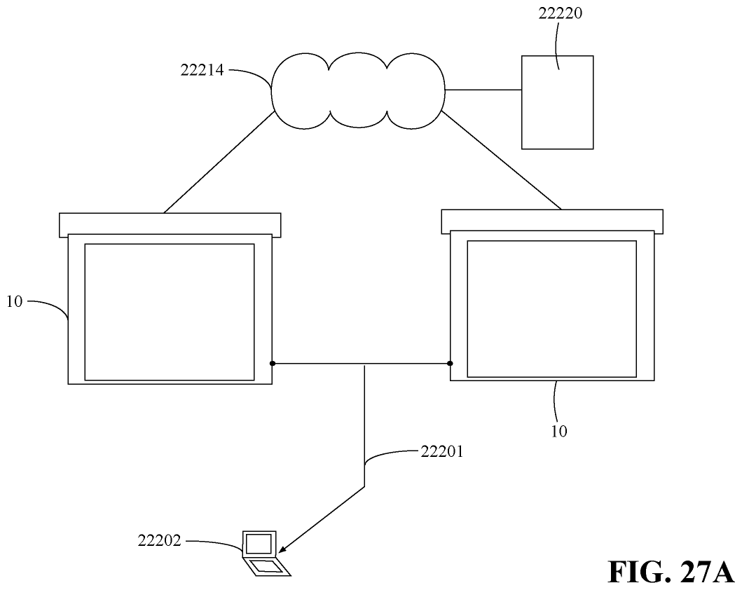

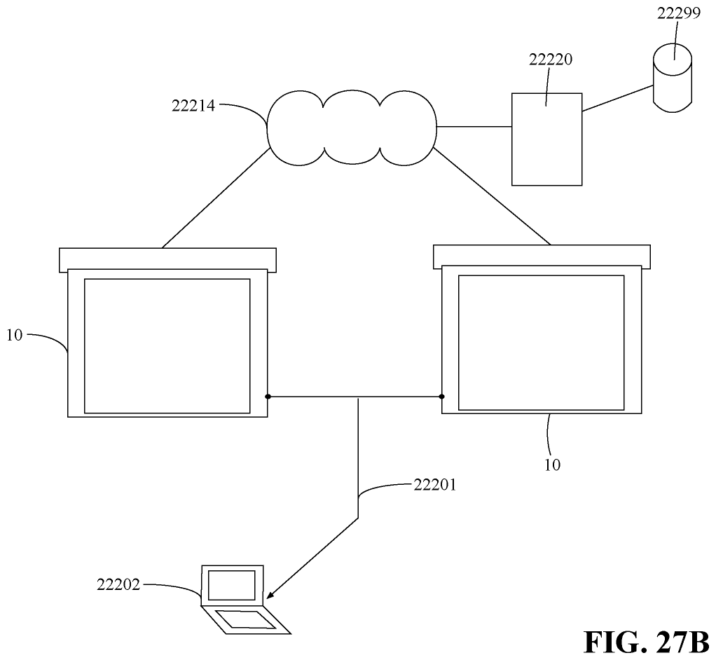

FIG. 27A is a diagram of multiple photovoltaic devices 10 connected in the same grid (22201) wherein the first (22100) and second (22200) photovoltaic devices are connected via a first grid (22201), wherein the first grid (22201) distributes energy to energy consuming devices (22202); wherein the photovoltaic devices 10 communicate via the wired or wireless network (22214) to a server (22220). In another embodiment of the technology the server may be located at one from the group of a computer, a photovoltaic device, a database; wherein the photovoltaic devices 10 connect to a server (22220) comprising a database further comprising weather forecasts, customized data, collected data.

In one embodiment of the technology the photovoltaic devices collect data comprising: energy harvesting data, energy distribution data, energy usage data.

In one embodiment of the technology the photovoltaic device is a photovoltaic window covering, for example photovoltaic blinds.

In another embodiment of the technology the grid is a DC grid.

In one embodiment of the technology the energy storage module is internal. In another embodiment of the technology the energy storage is external.

FIG. 27B shows another embodiment of the technology where the server (22220) further comprises communication with a smart device (22299), wherein the server sends notifications to the smart gadget and the gadget sends commands to the photovoltaic devices. Such commands comprising one or more from the group of: deploying the photovoltaic surface to be active, adjusting the tilt of the photovoltaic slates or photovoltaic material to point to the sun in a given direction.

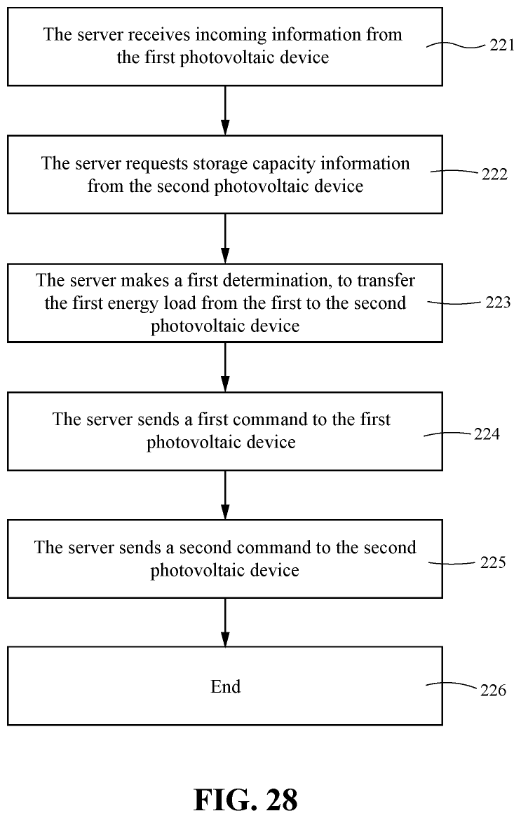

FIG. 28 is a flowchart explaining the step-by-step process the server follows in order to ensure successful communication between the photovoltaic devices, and to draw the first energy load.

Step 1 (221) the server receives a first communication from the first photovoltaic device informing that the energy storage module has reached a predetermined range.

Step 2 (222) the server requests storage capacity information from the second photovoltaic device; the second photovoltaic device responding to the request from the server.

Step 3 (223) the server makes a first determination, based in the storage capacity received from the second photovoltaic device, to transfer a first energy load from the first photovoltaic device to the second photovoltaic device, wherein the first energy load is the calculation of the amount of storage capacity available at the second photovoltaic device minus the projected amount of photovoltaic energy collection projected for the amount of time the first load will take to travel from the first photovoltaic device to the second photovoltaic device.

Step 4 (224) The server sends a first command to the first photovoltaic device to release the first energy load from its storage module to the first grid.

Step 5 (225) The server sends a second command to the second photovoltaic device to draw the first energy load from the first grid.

One familiar with the art will appreciate that the communication between 2 or more photovoltaic devices comprising their respective energy storage devices balances the load charges to each device's batteries

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1-8. (canceled)

9. A flexible solar panel, the flexible solar panel comprising: a support fixture; a flexible panel which is attached to the support fixture and includes a lower end; at least one solar cell that is retained on the flexible panel; a power hub which is in electrical communication with the solar cell; a flat cable in electrical communication with the power hub and a controller which includes: a power management system for use with one or more of a battery and an inverter; a processor; a memory; a network connection and a solar cell position controller.

10-17. (canceled)

18. A smart photovoltaic blind, the smart photovoltaic blind comprising: a blind which includes a multiplicity of vertical or horizontal slats; at least one solar cell mounted on the slats; a controller including a processor, a memory, a communication module, a power supply and a receiver transmitter module; a temperature sensor; at least one sensor selected from the group consisting of a photo sensor, a humidity sensor and a presence sensor; and a servo motor in electronic communication with the processor and in mechanical communication with the slats of the blind; wherein the memory is configured to instruct the processor upon receipt of a sensor reading to send instructions to the servo motor to adjust the slats to a desired angle.

19. A retractable, adherent photovoltaic blind for covering a window, the retractable, adherent photovoltaic blind comprising: a blind which includes an inside and an outside, the inside including an inside surface coating and the outside including an outside surface coating; at least one opaque, translucent or transparent solar cell which is mounted to the outside of the blind; and a ballast, which rotatably and releasably retains the blind; and a static charge inducer which is housed in the ballast, wherein the blind is configured to releasably adhere to the window.

20-21. (canceled)

22. The retractable, adherent photovoltaic blind of claim 19, wherein the static charge inducer is selected from the group consisting of a contact inducible static charge inducer, a pressure-inducible static charge inducer, a heat-inducible static charge inducer, and a charge-inducible static charge inducer.

23. A photovoltaic window covering strip, the photovoltaic window covering strip comprising: a strip which includes an inner surface and an outer surface; at least one solar cell mounted on the outer surface; and an adherent on the outer surface.

24. The photovoltaic window covering strip of claim 23, wherein the inner surface is a colored surface.

25. The photovoltaic window covering strip of claim 24, further comprising a light emitting diode in electrical communication with the solar cell. Support for the amendment is found in the application as originally filed at the third paragraph of page 30.

26. An energy storage and distribution system, the energy storage and distribution system comprising: a first photovoltaic device including a first photovoltaic energy harvesting module, a first energy storage module, a first controller comprising a processor, a memory and a wireless radio, and one or more first sensors selected from the group consisting of light, weather, temperature, energy use and energy storage sensors; a second photovoltaic device including a second photovoltaic energy harvesting module, a second energy storage module, a second controller comprising a processor, a memory and a wireless radio, and one or more second sensors selected from the group consisting of light, weather, temperature, energy use and energy storage sensors; a grid which is in electrical communication with the first photovoltaic device and the second photovoltaic device; and a server, which is in wireless communication with the first photovoltaic device and the second photovoltaic device, wherein the server is configured to receive a storage capacity dataset from each of the first photovoltaic device and the second photovoltaic device, determine whether an energy transfer between the first and second photovoltaic devices is required and instruct one photovoltaic device to transfer energy via the grid to the other photovoltaic device, as needed.

27. The retractable, adherent photovoltaic blind of claim 19, wherein the opaque, translucent or transparent solar cell includes a static repellent inside surface coating.

28. The retractable, adherent photovoltaic blind of claim 27, wherein the static charge inducer is a contact-inducible static charge inducer which configured to contact at least a portion of the outside surface coating.

29. The retractable, adherent photovoltaic blind of claim 22, wherein the opaque, translucent or transparent solar cell includes a static repellent inside surface coating.

30. The retractable, adherent photovoltaic blind of claim 29, wherein the static charge inducer is a contact-inducible static charge inducer which is configured to contact at least a portion of the outside surface coating.
